(19) United States
(12) Patent Application Publication
(10) Pub. No.: US 2026/0003356 A1
(43) Pub. Date: Jan. 1, 2026

(54) AUTONOMOUS MOVING APPARATUS, CONTROL SYSTEM FOR THE SAME, AND AUTONOMOUS MOVEMENT SYSTEM

(71) Applicant: ROHM CO., LTD., Kyoto-shi (JP)

(72) Inventors: Takashi NAIKI, Kyoto-shi (JP); Hiroshi YAGUMA, Kyoto-shi (JP)

(21) Appl. No.: 19/321,803

(22) Filed: Sep. 8, 2025

Related U.S. Application Data
(63) Continuation of application No. PCT/JP2024/007412, filed on Feb. 28, 2024.

(30) Foreign Application Priority Data
Mar. 15, 2023 (JP) 2023-040911
Mar. 20, 2023 (JP) 2023-044095

(51) Int. Cl. G05D 1/229; G05D 1/646; G05D 1/65

(52) U.S. Cl. CPC G05D 1/229; G05D 1/646; G05D 1/65

(57) ABSTRACT

An autonomous moving apparatus identifies a first attraction signal that is output from a first target object as an attraction signal, and causes a moving object to move, based on an incoming direction of the first attraction signal. When a position of the moving object relative to the first target object satisfies a predetermined condition, the attraction signal is switched from the first attraction signal to a second attraction signal that is output from a second target object, and the second attraction signal is identified as the attraction signal. An operation control unit causes the moving object to move, based on an incoming direction of the second attraction signal.

### CROSS REFERENCE TO RELATED APPLICATIONS

This application is a continuation under 35 U.S.C. § 120 of PCT Application No. PCT/JP2024/007412, filed on Feb. 28, 2024, which is incorporated herein by reference, and which claimed priority to Japanese Applications No. 2023-040911 filed on Mar. 15, 2023, and Japanese Application No. 2023-044095 filed on Mar. 20, 2023. The present application likewise claims priority under 35 U.S.C. § 119 to Japanese Application No. 2023-040911 filed on Mar. 15, 2023, and Japanese Application No. 2023-044095 filed on Mar. 20, 2023, the entire content of which is also incorporated herein by reference.

### TECHNICAL FIELD

The present disclosure relates to an autonomous moving apparatus, a control system for an autonomous moving apparatus, and an autonomous movement system.

### BACKGROUND

An autonomous moving apparatus is known, which receives a radio wave of a beacon output from a target object, and autonomously moves to the target object based on an incoming direction of the radio wave, while avoiding obstacles (see Patent Literature 1).

A following traveling device using an electronic traction technology (see Patent Literature 2), and an autonomous traveling device employing Simultaneous Localization And Mapping (SLAM) are known (see Patent Literature 3).

Patent Literature 1: WO 2022/181488

Patent Literature 2: JP 2021-142907 A

Patent Literature 3: JP 2023-18577 A

### BRIEF DESCRIPTION OF DRAWINGS

FIG. 1 is a schematic diagram for explaining a mechanism (digital pheromone), in which an autonomous moving apparatus 100 according to a plurality of embodiments reaches a target object (transmitting apparatus 200), while avoiding obstacles J1 and J2.

FIG. 2 is a plan view showing a state in which the autonomous moving apparatus 100 shown in FIG. 1 moves along a predetermined path K4, while sequentially receiving radio waves output from each of target objects 200a, 200b, 200c, and 200d.

FIG. 3 is a diagram for explaining the configuration of an autonomous movement system 1000 including the autonomous moving apparatus 100 and a control system according to the plurality of embodiments.

FIG. 4 is a schematic diagram showing first target identification information ID1 and travel switching information DC included in attraction signals PSa, PSb, PSc, and so forth output by target objects 200a, 200b, 200c, and so forth, respectively.

FIG. 5 is a schematic diagram showing the first target identification information ID1 and second target identification information ID2 included in the attraction signals PSa, PSb, PSc, and so forth output by the target objects 200a, 200b, 200c, and so forth, respectively.

FIG. 6 is a block diagram showing a state in which the autonomous moving apparatus 100 according to a third embodiment transmits and receives an identification signal DS to and from another autonomous moving apparatus 100.

FIG. 7 is a block diagram showing the configuration of the autonomous moving apparatus 100 according to a fourth embodiment and target objects 200.

FIG. 8 is a schematic diagram showing second target identification information ID2 and travel switching information DC included in target switching signals BCa, BCb, BCc, and so forth output by the target objects 200a, 200b, 200c, and so forth, respectively.

FIG. 9 is a block diagram showing the configuration of the autonomous moving apparatus 100 according to a fifth embodiment, the target objects 200, and target switching devices 300.

FIG. 10 is a block diagram showing the configuration of the autonomous moving apparatus 100 according to a sixth embodiment, the target objects 200, and an integrated control device 400.

FIG. 11 is a schematic diagram showing apparatus identification information FD and the second target identification information ID2 included in the target switching signals BCa, BCb, BCc, and so forth output by the target objects 200a, 200b, 200c, and so forth, respectively.

FIG. 12 is a schematic diagram showing a plurality of combinations of apparatus identification information DD and the second target identification information ID2 included in the target switching signals BCa, BCb, BCc, and so forth output by the target objects 200a, 200b, 200c, and so forth, respectively.

FIG. 13 is a schematic diagram showing the apparatus identification information FD, the second target identification information ID2, and the travel switching information DC included in the target switching signals BCa, BCb, BCc, and so forth output by the target objects 200a, 200b, 200c, and so forth, respectively.

FIG. 14 is a block diagram showing an example of the configuration of the autonomous moving apparatus 100 according to the plurality of embodiments.

FIG. 15 is a plan view showing a path K5 of the autonomous moving apparatus 100 in the autonomous movement system 1000 according to a reference example.

FIG. 16 is a block diagram showing the configuration of the autonomous movement system 1000 and the autonomous moving apparatus 100 according to a seventh embodiment.

FIG. 17 is a schematic diagram showing an example of a use scene according to Example 1 of the seventh embodiment.

FIG. 18 is a flowchart showing an example of an operation flow of the autonomous moving apparatus 100 according to Example 2 of the seventh embodiment.

### DETAILED DESCRIPTION

### (Outline of Autonomous Moving Apparatus)

An autonomous moving apparatus, a control system for an autonomous moving apparatus, and an autonomous movement system according to a plurality of embodiments will be described below in detail with reference to the drawings. It should be noted that embodiments described below show exhaustive or specific examples. Numerical values, shapes, materials, constituent elements, and installation positions and connection forms of constituent elements described in the following embodiments are examples and are not intended to be limited to those of the present disclosure. Further, among constituent elements in the following embodiments, constituent elements not recited in independent claims indicating the most significant concept are described as optional constituent elements. Still further, the dimensional ratios in the drawings are exaggerated for illustrative purposes and may differ from the actual ratios.

In addition, the following embodiments and modified examples thereof may include similar constituent elements, and therefore the similar constituent elements are denoted with a common reference numeral to omit duplicated descriptions thereof.

A moving object on which an autonomous moving apparatus according to a plurality of embodiments is mounted, can be used in the internal space or, in some cases, in the external space of buildings such as houses and offices and structures such as factories, and has a configuration of autonomously reaching a target object, for example. Further, by using a propeller or the like which enables aerial movement for a moving mechanism, a flying object such as what is referred to as a drone can autonomously reach a target object, for example. Further, the autonomous moving apparatus can be used for moving objects such as vehicles including passenger cars and buses, aircraft, spacecraft, ships, and submersibles. In the embodiments, a description will be given by taking, as examples, vehicles with wheels such as passenger cars and buses as moving objects.

The autonomous moving apparatus does not use an imaging device such as a camera, Light Detection And Ranging (LiDAR), and radar, but reaches the target object using information output by the target object, while avoiding an obstacle. Although there are no particular limitations, examples of the information output by the target object include radio waves or high-frequency electromagnetic waves. Hereinafter, a description will be given by taking a radio wave as an example. The autonomous moving apparatus receives a radio wave such as a beacon using a plurality of antennas thereof, uses a technique for estimating an incoming direction of the radio wave to estimate a direction of the target object which emits the radio wave, and moves in the estimated direction. If an obstacle is present outside a line-of-sight between the target object and the autonomous moving apparatus, the autonomous moving apparatus may move in an incoming direction of a radio wave reflected by the obstacle. However, the autonomous moving apparatus may receive a radio wave directly received from the target object during movement. In this case, the autonomous moving apparatus can change a movement direction thereof in a direction of the target object on the way to move toward the obstacle. As a result, the autonomous moving apparatus can move toward the target object, while avoiding the obstacle. In addition, if an obstacle is present on the line-of-sight between the target object and the autonomous moving apparatus, the autonomous moving apparatus can detect the presence of the obstacle, because the reception intensity of a radio wave oscillates as the autonomous moving apparatus moves toward the obstacle. In this way, the autonomous moving apparatus can reach the target object, while avoiding the obstacle, by continuously moving in a direction where the reception intensity of the radio waves is high, while estimating an incoming direction of a radio wave.

As described above, it is not necessary for the autonomous moving apparatus to have an imaging device such as a CCD camera, LiDAR, and radar for route search which have been employed in a conventional technique. In addition, as in the case of an autonomous traveling vehicle adopting SLAM, when the autonomous moving apparatus is introduced to a new location, each time a layout of a previous location is changed, it is not necessary to create a map of the location or layout. In other words, the autonomous moving apparatus of the present disclosure can reach a target object which outputs a radio wave by having an antenna for receiving the radio wave, and a control unit and a drive unit for the autonomous moving apparatus to move in an incoming direction of the radio wave, while measuring the intensity of the radio wave. In addition, acoustic waves emitted from a speaker mounted on the autonomous moving apparatus are reflected by objects in the periphery of the autonomous moving apparatus and based on the acoustic waves received by a plurality of microphones, the movement direction of the autonomous moving apparatus can be set. Therefore, the movement direction of the autonomous moving apparatus can be set by avoiding a narrow travel path or an intricate and complicated travel path. As a result, the autonomous moving apparatus can reach the target object, while selecting a suitable travel path which is less affected by objects (including obstacles) in the periphery of the autonomous moving apparatus.

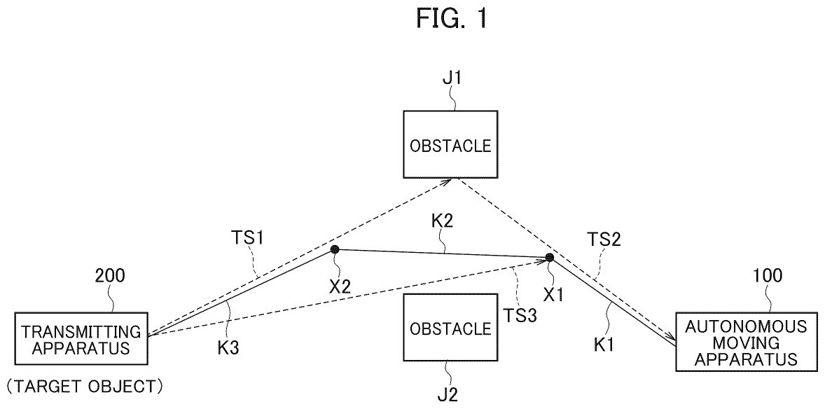

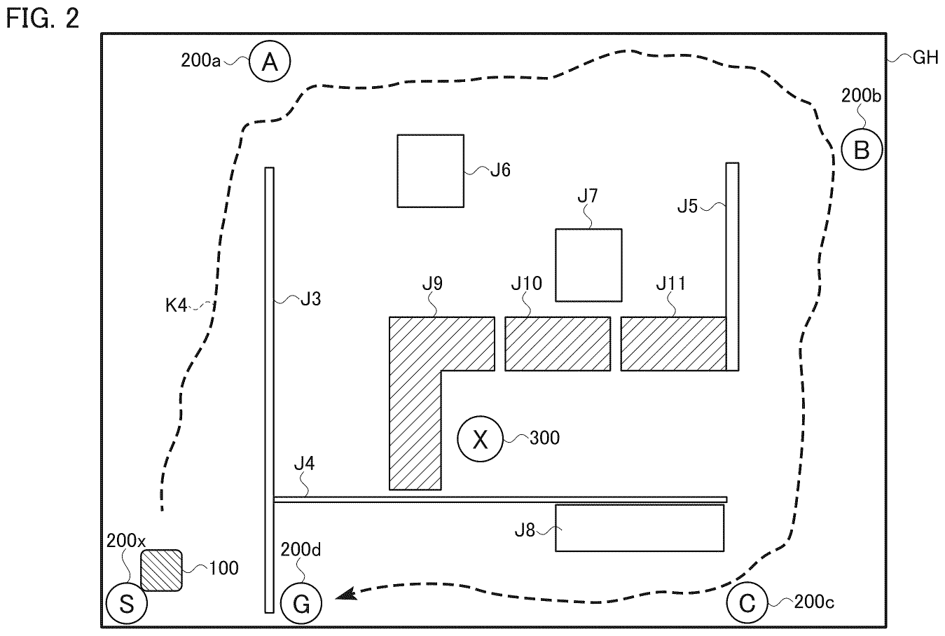

Next, with reference to FIG. 1 and FIG. 2, a general description will be given regarding outlines of an autonomous moving apparatus 100 according to a plurality of embodiments, and an autonomous movement system 1000 including the autonomous moving apparatus 100.

First, with reference to FIG. 1, a mechanism (digital pheromone) will be described, in which the autonomous moving apparatus 100 continuously moves in a direction where the reception intensity of a radio wave such as a beacon is high, while estimating an incoming direction of the radio wave, and as a result the autonomous moving apparatus 100 reaches a target object (transmitting apparatus 200), while avoiding obstacles J1 and J2. The autonomous moving apparatus 100 receives a radio wave transmitted from the transmitting apparatus 200 disposed on the target object. Since a line-of-sight between the autonomous moving apparatus 100 and the transmitting apparatus 200 is blocked by the obstacle J2, the autonomous moving apparatus 100 receives the radio wave via a path K3→a path K2→a path K1. There is a possibility that the autonomous moving apparatus 100 receives a radio wave from the line-of-sight direction also, depending on the size of the obstacle J2 and a frequency of a beacon. However, it is assumed that a radio wave received via the path K1 has the highest intensity. The autonomous moving apparatus 100 estimates an incoming direction of a radio wave with the highest intensity using a plurality of antennas mounted on the autonomous moving apparatus 100 and moves based on the estimated incoming direction.

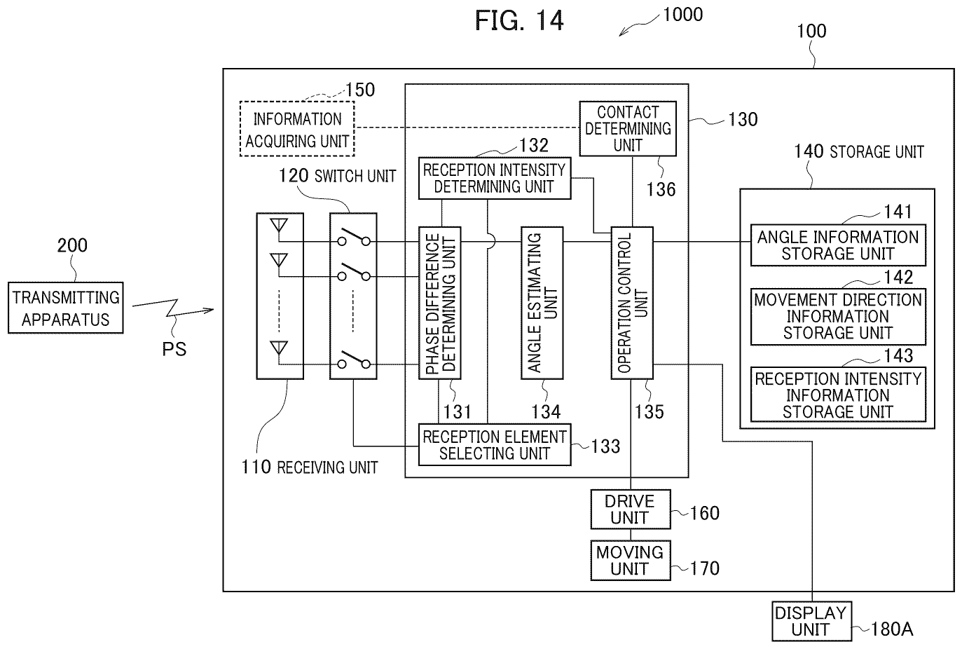

The autonomous moving apparatus 100 moving on the path K1 toward the obstacle J1 continuously moves on the path K1 toward the obstacle J1, because the reception intensity of a radio wave increases as the autonomous moving apparatus 100 approaches the obstacle J1. However, when the autonomous moving apparatus 100 reaches a position X1, the transmitting apparatus 200 appears ahead of the line-of-sight of the autonomous moving apparatus 100, and therefore the autonomous moving apparatus 100 can directly receive a radio wave TS3. Since the reception intensity of the radio wave TS3 is higher than that of a radio wave TS2 at the position X1, the autonomous moving apparatus 100 attempts to change a movement direction to an incoming direction of the radio wave TS3. The autonomous moving apparatus 100 can move on the line of the incoming direction of the radio wave TS3, but in that case, there is a possibility that the autonomous moving apparatus 100 collides with the obstacle J2. Therefore, based on a fact that the autonomous moving apparatus 100 could not receive the radio wave TS3, until the autonomous moving apparatus 100 reaches the position X1 along the path K1, and based on an estimated incoming direction of the radio wave TS3 with a high intensity received when the autonomous moving apparatus 100 is at the position X1, the autonomous moving apparatus 100 recognizes the presence of the obstacle J2 and moves in a direction of the path K2. Further, based on a fact that an incoming direction of a radio wave output from the transmitting apparatus 200 is gradually widened toward a traveling direction of the autonomous moving apparatus 100, and based on a change in the movement direction at the position X1, the autonomous moving apparatus 100 moving in the direction of the path K2 can recognize the presence of the obstacle J1 and can estimate the path K3. Therefore, the autonomous moving apparatus 100 can change the traveling direction toward the transmitting apparatus 200 at a position X2 and can reach the transmitting apparatus 200. WO 2022/181488 also discloses a detailed configuration example for implementing the digital pheromone configuration of the autonomous moving apparatus 100 described above, and the detailed configuration example will be described later with reference to FIG. 14.

FIG. 2 is a plan view showing a state in which the autonomous moving apparatus 100 shown in FIG. 1 moves along a predetermined path K4, while sequentially receiving radio waves output from each of target objects 200a, 200b, 200c, and 200d. FIG. 2 shows a layout in an internal space GH of a structure such as a factory. The autonomous moving apparatus 100 is an Autonomous Mobile Robot (AMR) and moves along the path K4 in the internal space GH of a factory or warehouse, for example. The path K4 is a suitable path for the autonomous moving apparatus 100 to reach a target object 200d (final target object) from a start point 200x, while bypassing various obstacles J3 to J11 arranged in the internal space GH.

The autonomous moving apparatus 100 located at the start point 200x first receives an attraction signal (first attraction signal) output from the target object 200a (first target object) using an antenna thereof. Based on the operation principle described with reference to FIG. 1, the autonomous moving apparatus 100 moves to the target object 200a based on an incoming direction of the attraction signal of the target object 200a. When the autonomous moving apparatus 100 reaches the target object 200a, the autonomous moving apparatus 100 switches a target object from the target object 200a to the target object 200b. In other words, the autonomous moving apparatus 100 switches an attraction signal to be identified from the attraction signal (first attraction signal) output by the target object 200a, to an attraction signal (second attraction signal) output by the target object 200b. The autonomous moving apparatus 100 receives the attraction signal (second attraction signal) output by the target object 200b using the antenna thereof and moves to the target object 200b based on an incoming direction of the attraction signal.

As described above, when a position of the autonomous moving apparatus 100 relative to a target object satisfies a predetermined condition, the autonomous moving apparatus 100 switches a target object and an attraction signal output by the target object to a next target object and a next attraction signal output by the target object. By repeating the switching, the autonomous moving apparatus 100 can autonomously travel along the path K4 for reaching the target object 200d from the start point 200x via the target object 200a, the target object 200b, and the target object 200c. Instead of the autonomous moving apparatus 100 itself determining the predetermined condition described above and switching a target object and an attraction signal, a control system including the plurality of target objects 200a to 200d may determine the predetermined condition described above and control the autonomous moving apparatus 100 to switch a target object or an attraction signal. In the latter case, the control system can move the autonomous moving apparatus 100 along the appropriate path K4.

FIG. 2 shows an example of the autonomous movement system 1000, and the example of the autonomous movement system 1000 includes the autonomous moving apparatus 100, and the control system including the plurality of target objects 200a to 200d. In FIG. 2, the obstacles J3 to J8 allow radio waves to easily pass therethrough, and the obstacles J9 to J11 are metallic obstacles which shield radio waves.

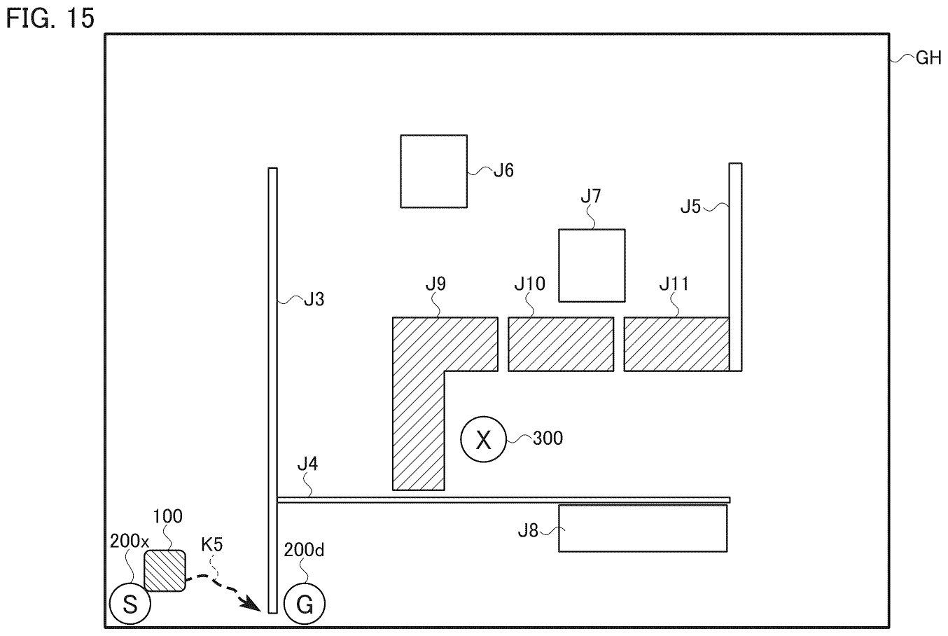

Meanwhile, FIG. 15 shows a path K5 when the autonomous moving apparatus 100 moves from the start point 200x based on an incoming direction of an attraction signal output by the target object 200d (final target object), and the autonomous moving apparatus 100 does not switch a target object and an attraction signal output by the target object. As shown in FIG. 15, the autonomous moving apparatus 100 moves based on an incoming direction of a radio wave of the target object 200d, which passes through the obstacle J3. Therefore, it is not possible for the autonomous moving apparatus 100 to move along the path K4 in FIG. 2, which bypasses the obstacles J3 to J11, and it is not possible for the autonomous moving apparatus 100 to reach the target object 200d, because the path is blocked by the obstacle J3.

Various obstacles which reflect or diffract radio waves are arranged in the internal space GH of a factory site, and examples of the obstacles include large metallic apparatuses, metallic partitions (with or without glass windows), ceilings, and floors. Therefore, a direct wave from the target object 200 does not reach the autonomous moving apparatus 100. The autonomous moving apparatus 100 receives reflected waves and the like which have been reflected or diffracted a plurality of times, or the reflected waves interfere with each other in complicated ways. Therefore, an incoming direction of a radio wave, and a change in the radio wave intensity due to the movement of the autonomous moving apparatus 100 become complicated. Therefore, as shown in FIG. 2, if the target objects 200a to 200d are individually arranged at a plurality of positions where direct waves can be easily received as much as possible, this kind of complication in an incoming direction of a radio wave, and the radio wave intensity can be reduced.

### First Embodiment

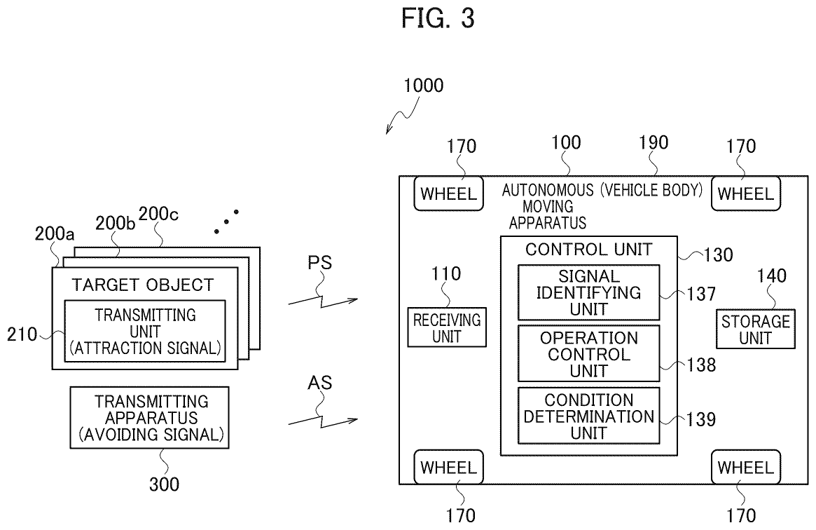

In first to third embodiments, embodiments of the autonomous moving apparatus 100 will be described. First, with reference to FIG. 3, a description will be given regarding a configuration of the autonomous movement system 1000 including the autonomous moving apparatus 100 according to the first embodiment, and the control system. The autonomous moving apparatus 100 according to the first embodiment includes a receiving unit 110, a signal identifying unit 137, and an operation control unit 138. The receiving unit 110 is attached to a vehicle body 190 of a vehicle, and receives signals output from the target objects 200a, 200b, 200c, and so forth (hereinafter may be collectively referred to as “target objects 200”). The signal identifying unit 137 identifies an attraction signal PS from the received signals. The operation control unit 138 causes the vehicle body 190 to move, based on an incoming direction of the identified attraction signal PS.

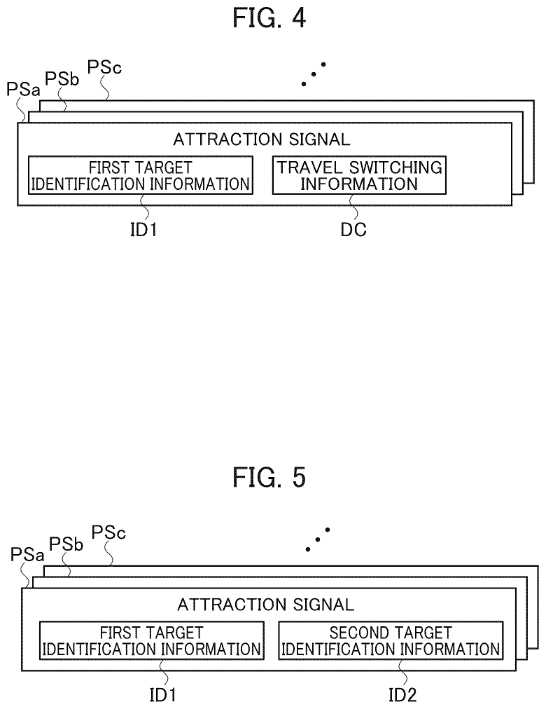

The autonomous moving apparatus 100 operates based on the following procedure. First, as the attraction signal PS, the signal identifying unit 137 identifies an attraction signal PSa (first attraction signal) shown in FIG. 4, which is output from the target object 200a (first target object) shown in FIG. 3. The operation control unit 138 causes the vehicle body 190 to move, based on an incoming direction of the identified attraction signal PSa. Suppose that a position of the vehicle body 190 relative to the target object 200a satisfies a predetermined condition. In the above case, the signal identifying unit 137 switches an attraction signal from the attraction signal PSa to an attraction signal PSb (second attraction signal) which is output from the target object 200b (second target object) and identifies the attraction signal PSb as the attraction signal. The operation control unit 138 causes the vehicle body 190 to move, based on an incoming direction of the attraction signal PSb.

When the position of the vehicle body 190 relative to the target object 200a satisfies the predetermined condition, the signal identifying unit 137 switches an attraction signal to be identified, to an attraction signal output from a target object toward which the autonomous moving apparatus 100 should move next. As a result, the autonomous moving apparatus 100 can autonomously travel along a path for reaching the target object 200b via the target object 200a. Further, by repeatedly switching attraction signals PSa, PSb, PSc, and so forth (hereinafter may be collectively referred to as “attraction signals PS”), as shown in FIG. 2, the autonomous moving apparatus 100 can autonomously move along the appropriate path K4 for reaching the target object 200d from the start point 200x via the target object 200a, the target object 200b, and the target object 200c.

A moving object according to the embodiment may constitute a vehicle including the vehicle body 190 forming a skeleton thereof, and a plurality of wheels 170 (an example of a moving unit) attached to the vehicle body 190, for example. In this case, the vehicle has a drive source such as an internal combustion engine or a motor for driving the wheels 170. A control unit 130 estimates an incoming direction of the identified attraction signal PSa and determines the movement direction of the autonomous moving apparatus 100 (vehicle body 190) based on the incoming direction. The control unit 130 controls the rotating speed of each wheel 170 to move the vehicle body 190 toward the determined movement direction. A detailed configuration of the autonomous moving apparatus 100 will be described later with reference to FIG. 14.

The target objects 200 output different attraction signals PS. Specifically, as shown in FIG. 4, the attraction signals PSa, PSb, PSc, and so forth output by the target objects 200a, 200b, 200c, and so forth, respectively include different pieces of first target identification information ID1. The signal identifying unit 137 can identify a specific attraction signal PS and a specific target object 200 which outputs the attraction signal PS, from another attraction signal PS and another target object 200, based on the first target identification information ID1 included in the attraction signal PS.

The autonomous moving apparatus 100 may further include a storage unit 140 shown in FIG. 3. In this case, the storage unit 140 stores data in which the order of attraction signals identified by the signal identifying unit 137 is determined. In other words, the storage unit 140 may store in advance information indicating the order of attraction signals to be identified. The autonomous moving apparatus 100 switches the attraction signals to be identified according to the predetermined order stored in the storage unit 140, and as a result, the autonomous moving apparatus 100 can move along the path K4 which is appropriate for the autonomous moving apparatus 100 to reach the final target object (target object 200d), while avoiding the obstacles as shown in FIG. 2.

The autonomous moving apparatus 100 may further include a condition determination unit 139 shown in FIG. 3. The condition determination unit 139 determines whether the position of the vehicle body 190 relative to the target object 200a satisfies the above-described “predetermined condition”, based on at least one of the strength of the attraction signal PSa shown in FIG. 4, which is received by the receiving unit 110, and the time change of the signal strength. The “predetermined condition” is a condition determined in advance concerning the distance from the target object 200a to the vehicle body 190. Specifically, the predetermined condition means that the autonomous moving apparatus 100 approaches the target object 200a, to the extent that the autonomous moving apparatus 100 can travel along the path K4 determined in advance (see FIG. 2). In other words, the “predetermined condition” means that a value of the distance from the autonomous moving apparatus 100 to the target object 200a is a predetermined reference value or less. In the layout shown in FIG. 2, the “predetermined condition” for switching a target object from the target object 200a to the target object 200b means that, the autonomous moving apparatus 100 approaches the target object 200a, to the extent that the obstacle J3 or the obstacle J6 can be bypassed, for example. In this way, the “predetermined condition” is a matter appropriately set so that the autonomous moving apparatus 100 can travel along the appropriate path K4 for reaching the final target object (target object 200d in FIG. 2), while avoiding the obstacles.

The reception intensity of radio waves of the attraction signals PS and the like varies, depending on the distance between transmitting and receiving devices. The reception intensity of radio waves becomes higher as the distance between the transmitting and receiving devices becomes shorter. The condition determination unit 139 can estimate the distance from the autonomous moving apparatus 100 to the target object 200a based on a Received signal strength Indicator (RSSI) of the attraction signal PSa and can determine whether the predetermined condition described above is satisfied, based on the estimated distance. The condition determination unit 139 may determine that the predetermined condition is satisfied, when the distance value is smaller than the predetermined reference value. Further, when the autonomous moving apparatus 100 is moving toward the target object 200a, the time change rate of the distance described above is the predetermined reference value or above. However, when the autonomous moving apparatus 100 reaches a location in the vicinity of the target object 200a, the time change rate of the distance described above becomes less than the predetermined reference value. Therefore, the condition determination unit 139 may determine whether the predetermined condition described above is satisfied, based on the time change rate of the strength of the attraction signal PSa. Specifically, the condition determination unit 139 may determine that the predetermined condition is satisfied, when the time change rate of the distance described above is lower than the predetermined reference value. Still further, the condition determination unit 139 may determine the predetermined condition by combining the distance, and the time change rate of the distance described above. Alternatively, a camera image or other known area intrusion detection means may be used. These methods for determining the “predetermined condition” are applicable to all the embodiments and modified examples thereof described in the present specification.

As shown in FIG. 4, each of the attraction signals PS may include travel switching information DC for switching at least one of the movement and temporary stop, movement speed, and travel algorithm of the autonomous moving apparatus 100. In this case, the operation control unit 138 switches at least one of the movement and temporary stop, movement speed, and travel algorithm of the autonomous moving apparatus 100 based on the travel switching information DC. The autonomous moving apparatus 100 can move toward the target object 200 by changing the movement and temporary stop, traveling speed, and travel algorithm. When the number of people entering the internal space GH shown in FIG. 2 is the predetermined number or more, the autonomous moving apparatus 100 is temporarily stopped, the movement speed thereof is decreased, or a path search algorithm is switched to a more careful method, for example. Alternatively, when a trouble or disaster occurs in the autonomous moving apparatus 100, a mode of the autonomous moving apparatus 100 is switched to a standby mode or an evacuation mode programmed in advance in the autonomous moving apparatus 100. An algorithm can be switched to the travel algorithm based on the determination made by an integrated control device 400, which will be described later, or a manager of the control system. Control commands for comprehensively responding to a situation in the internal space GH may be simultaneously informed in the internal space GH or may be informed to a limited area.

The signal identifying unit 137 may identify an avoiding signal AS from received signals. In this case, the operation control unit 138 causes the vehicle body 190 to move in a direction where the strength of the avoiding signal AS decreases, based on an incoming direction of the identified attraction signal PS. As shown in FIG. 3, the avoiding signal AS is included in a radio wave transmitted from a transmitting apparatus 300 which is different from the target object 200. The operation control unit 138 is set in advance such that the autonomous moving apparatus 100 including the operation control unit 138 does not approach the transmitting apparatus 300. In other words, a travel algorithm is incorporated in the operation control unit 138, and the travel algorithm prevents the autonomous moving apparatus 100 including the operation control unit 138 from moving in a direction where the strength of the avoiding signal AS increases. In the internal space GH shown in FIG. 2, there is an area surrounded by the obstacles J4 and J9 to J11, but the area is spaced apart from the proper path K4, for example. Therefore, by arranging the transmitting apparatus 300 which outputs the avoiding signal AS in this area, it is possible to prevent the autonomous moving apparatus 100 from entering the area. Similarly to the plurality of target objects 200a to 200d, the transmitting apparatus 300 is one of components constituting the control system of the autonomous moving apparatus 100.

### Second Embodiment

The first embodiment shows a case where the storage unit 140 of the autonomous moving apparatus 100 stores in advance the data in which the switching order of attraction signals is determined. As one of alternative means thereof, the second embodiment describes an example in which an attraction signal to be identified is switched from a first attraction signal PSa to a second attraction signal PSb using a second target identification information ID2 included in the first attraction signal PSa as shown in FIG. 5.

As shown in FIG. 5, the first attraction signal PSa may include the first target identification information ID1 used by the signal identifying unit 137 to identify the first attraction signal PSa, and the second target identification information ID2 used by the signal identifying unit 137 to identify the second attraction signal PSb. The signal identifying unit 137 can switch a specific signal from the first attraction signal PSa to the second attraction signal PSb based on the second target identification information ID2 included in the first attraction signal PSa.

The second target identification information ID2 included in the first attraction signal PSa is information for identifying an attraction signal after switching (second attraction signal PSb), when a position of the vehicle body 190 relative to a first target object 200a satisfies the “predetermined condition”.

As described above, the attraction signal PSa before switching is caused to include not only the target identification information ID1 for identifying the attraction signal PSa before switching, but also the target identification information ID2 for identifying the attraction signal PSb after switching. This eliminates the necessity to dispose the storage unit 140 which stores the data in which the switching order of attraction signals is determined. Further, since the attraction signal PSb after switching changes by changing the target identification information ID2 included in the attraction signal PSa before switching, the control system having the target objects 200 can control a path along which the autonomous moving apparatus 100 moves.

### Third Embodiment

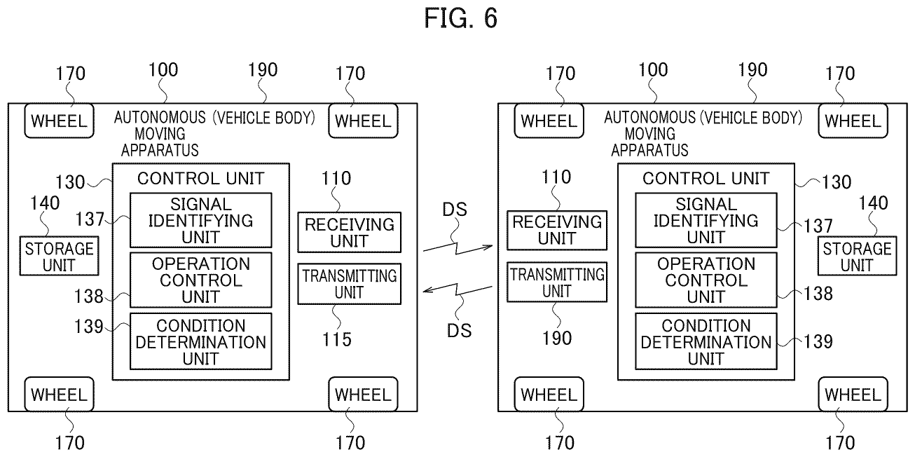

With reference to FIG. 6, the third embodiment describes an example in which the autonomous moving apparatus 100 transmits an identification signal DS for identifying the autonomous moving apparatus 100 in question. FIG. 6 is a block diagram showing a state in which the autonomous moving apparatus 100 according to the third embodiment transmits and receives the identification signal DS to and from another autonomous moving apparatus 100. The autonomous moving apparatus 100 may further include a transmitting unit 115 which transmits the identification signal DS including information for identifying the autonomous moving apparatus 100 in question from the other autonomous moving apparatus 100, and information indicating priority with the other autonomous moving apparatus 100. The signal identifying unit 137 identifies an identification signal DS output from the other autonomous moving apparatus 100, among signals received by the receiving unit 110. The operation control unit 138 controls an operation of the autonomous moving apparatus 100 in question relative to the other autonomous moving apparatus 100 based on the identified priority, when a position of the vehicle body 190 of the autonomous moving apparatus 100 in question relative to the other autonomous moving apparatus 100 satisfies the “predetermined condition”. Specifically, the operation control unit 138 estimates the distance from the other autonomous moving apparatus 100 to the vehicle body 190 of the autonomous moving apparatus 100 in question based on the strength of the identification signal DS and determines that the “predetermined condition” is satisfied, when the estimated distance value becomes the predetermined reference value or less.

If the priority of the other autonomous moving apparatus 100 satisfying the “predetermined condition” is higher than the priority of the autonomous moving apparatus 100 in question, the operation control unit 138 temporarily stops the vehicle body 190, for example. Alternatively, the autonomous moving apparatus 100 in question may move backward a certain distance and then stop. Meanwhile, since the priority of the other autonomous moving apparatus 100 is higher than the priority of the autonomous moving apparatus 100 in question, the other autonomous moving apparatus 100 continuously moves. As a result, the autonomous moving apparatus 100 having a lower priority can give the autonomous moving apparatus 100 having a higher priority the road. The autonomous moving apparatus 100 having a higher priority can recognize the temporarily stopped autonomous moving apparatus 100 as a stationary obstacle. As a result, even when a plurality of autonomous moving apparatuses 100 are present in a mixed state in the internal space GH shown in FIG. 2, collision and deadlock between the autonomous moving apparatuses 100 can be suppressed, and each autonomous moving apparatus 100 can move smoothly.

### Fourth Embodiment

In fourth to sixth embodiments, embodiments of the control system for controlling the autonomous moving apparatus 100 will be described. As shown in FIGS. 4, FIG. 5, FIG. 7, and FIG. 8, the control system of the autonomous moving apparatus 100 has the plurality of target objects 200a, 200b, 200c, and so forth which output the different attraction signals PSa, PSb, PSc, and so forth. When the relative position of the autonomous moving apparatus 100 satisfies the predetermined condition, the plurality of target objects 200 output target switching signals BCa, BCb, BCc, and so forth (hereinafter may be collectively referred to as “target switching signals BC”) for causing the autonomous moving apparatus 100 to switch the attraction signals to be identified PSa, PSb, PSc, and so forth.

When the position of the autonomous moving apparatus 100 relative to the target object 200 satisfies the predetermined condition, the target object 200 outputs the target switching signal BC for switching an attraction signal to be identified, to an attraction signal output from a target object toward which the autonomous moving apparatus 100 should move next. This allows the autonomous moving apparatus 100 which has received the target switching signal BC to switch the attraction signal to be identified. As a result, the control system of the autonomous moving apparatus 100 can cause the autonomous moving apparatus 100 to move along a path for reaching the target object 200b via the target object 200a. Due to the plurality of target objects 200 individually transmitting the target switching signals BC, the control system of the autonomous moving apparatus 100 can cause the autonomous moving apparatus 100 to autonomously move along the appropriate path K4 for reaching the target object 200d from the start point 200x via the target object 200a, the target object 200b, and the target object 200c as shown in FIG. 2.

As in the first embodiment, the target object 200 includes a transmitting unit 210 which transmits the attraction signal PS. The autonomous moving apparatus 100 includes the receiving unit 110 which receives signals output from the target object 200, the signal identifying unit 137 which identifies the attraction signal PS and target switching signal BC, among the received signals, and the operation control unit 138 which causes the vehicle body 190 to move, based on an incoming direction of the identified attraction signal PS.

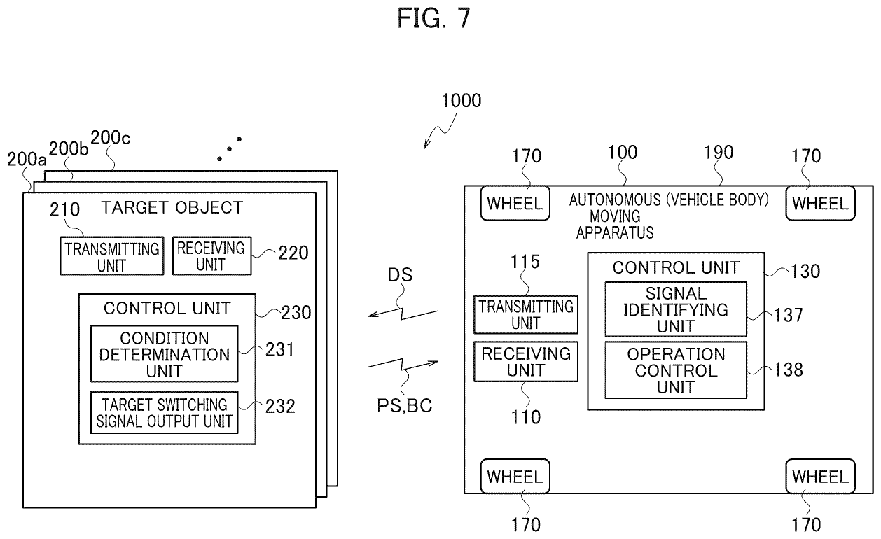

As shown in FIG. 7 the autonomous moving apparatus 100 according to the fourth embodiment may include the transmitting unit 115 which transmits the identification signal DS including the information for identifying the autonomous moving apparatus 100 in question from the other autonomous moving apparatus. Each of the plurality of target objects 200 may include a receiving unit 220 and a condition determination unit 231. The receiving unit 220 receives the identification signal DS output from the autonomous moving apparatus 100. The condition determination unit 231 determines whether the position of the autonomous moving apparatus 100 relative to the target object 200 satisfies the predetermined condition, based on at least one of the strength of the identification signal DS received by the receiving unit 220, and the time change of the signal strength. Since the “predetermined condition” has already been described in the first embodiment, a description thereof is omitted here. When the condition determination unit 231 determines that the relative position has satisfied the predetermined condition, a target switching signal output unit 232 controls the transmitting unit 210 to output the target switching signal BC from the transmitting unit 210. As a result, the control system can cause the autonomous moving apparatus 100 to autonomously move along the appropriate path K4 for reaching the final target object (target object 200d in FIG. 2), while avoiding the obstacles. As the identification signal DS, it is possible to use an advertising signal such as Bluetooth (registered trademark), for example. In this case, a payload can include identification information of the autonomous moving apparatus 100. As will be described later, the target object 200 may output the target switching signal BC which is different according to the identification information of the autonomous moving apparatus 100. As a result, the control system can cause the autonomous moving apparatus 100 to travel along a path which is different according to the autonomous moving apparatus 100.

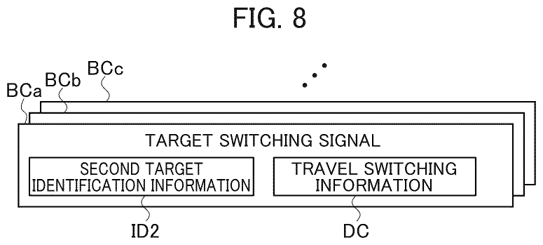

As shown in FIG. 8, each of the target switching signals BC may include travel switching information for switching at least one of the movement and temporary stop, movement speed, and travel algorithm of the autonomous moving apparatus 100. In this case, the operation control unit 138, which has received the target switching signals BC, switches at least one of the movement and temporary stop, movement speed, and travel algorithm of the autonomous moving apparatus 100, based on the travel switching information. The autonomous moving apparatus 100 can move toward the target object 200 after switching by switching the target object 200, and changing the movement and temporary stop, traveling speed, and travel algorithm. When the number of people entering the internal space GH shown in FIG. 2 is the predetermined number or more, the autonomous moving apparatus 100 is temporarily stopped, the movement speed thereof is decreased, or a path search algorithm is switched to a more careful method, for example. Alternatively, when a trouble or disaster occurs in the autonomous moving apparatus 100, a mode of the autonomous moving apparatus 100 is switched to a standby mode or an evacuation mode programmed in advance in the autonomous moving apparatus 100. An algorithm can be switched to the travel algorithm based on the determination made by the integrated control device 400, which will be described later, or a manager. Control commands for comprehensively responding to a situation in the internal space GH may be simultaneously informed in the internal space GH or may be informed to a limited area.

### Fifth Embodiment

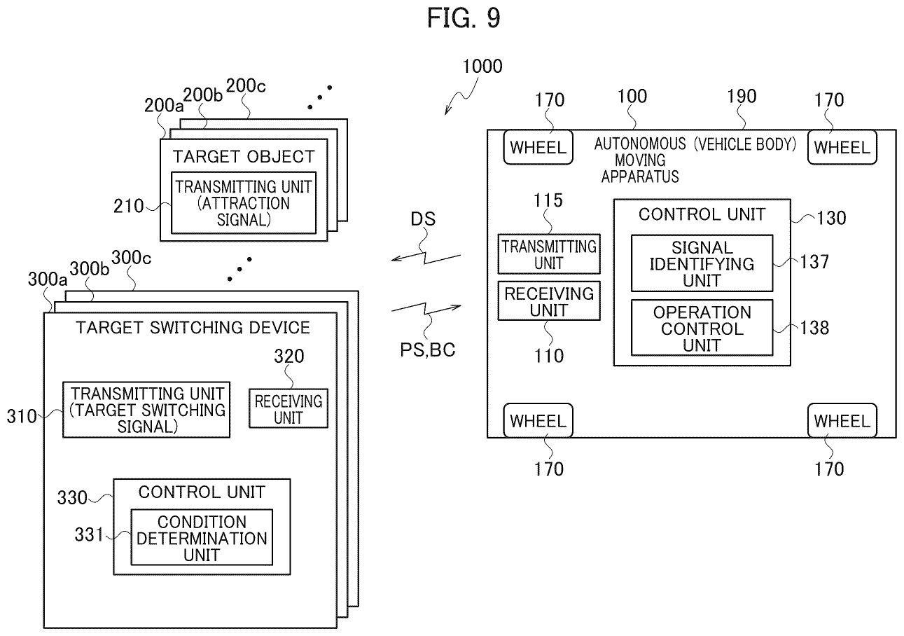

As shown in FIG. 9, the control system according to the fifth embodiment further includes a plurality of target switching devices 300a, 300b, 300c, and so forth (hereinafter may be collectively referred to as “target switching devices 300”) which output the target switching signals BC, when the relative position of the autonomous moving apparatus 100 satisfies the predetermined condition. Meanwhile, each of the target objects 200 includes the transmitting unit 210.

When a position of the vehicle body 190 relative to the target switching device 300 satisfies the predetermined condition, the target switching device 300 outputs the target switching signal BC for switching, an attraction signal to be identified, to an attraction signal output from a target object toward which the autonomous moving apparatus 100 should move next. This allows the autonomous moving apparatus 100 which has received the target switching signal BC to switch the attraction signal to be identified. The control system of the autonomous moving apparatus 100 can cause the autonomous moving apparatus 100 to move along a path for reaching the target object 200b via the target object 200a. Due to the plurality of target switching devices 300 individually transmitting the target switching signals BC, the control system of the autonomous moving apparatus 100 can cause the autonomous moving apparatus 100 to autonomously move along the appropriate path K4 for reaching the target object 200d from the start point 200x via the target object 200a, the target object 200b, and the target object 200c as shown in FIG. 2. Each target object 200 and each target switching device 300 act as a pair, and are arranged in the internal space GH shown in FIG. 2.

As shown in FIG. 9, the autonomous moving apparatus 100 according to the fifth embodiment may include the transmitting unit 115 which transmits the identification signal DS including, the information for identifying the autonomous moving apparatus 100 in question from the other autonomous moving apparatus. Each of the plurality of target switching devices 300 may include a receiving unit 320 and a condition determination unit 331. The receiving unit 320 receives the identification signal DS output from the autonomous moving apparatus 100. The condition determination unit 331 determines whether the position of the target switching device 300 relative to the target object 200 satisfies the predetermined condition, based on at least one of the strength of the identification signal DS received by the receiving unit 320, and the time change of the signal strength. Since the “predetermined condition” has already been described in the first embodiment, a description thereof is omitted here. When the condition determination unit 331 determines that the relative position has satisfied the predetermined condition, the transmitting unit 210 outputs the target switching signal BC. As a result, the control system can cause the autonomous moving apparatus 100 to autonomously move along the appropriate path K4 for reaching the final target object (target object 200d in FIG. 2), while avoiding the obstacles.

### Sixth Embodiment

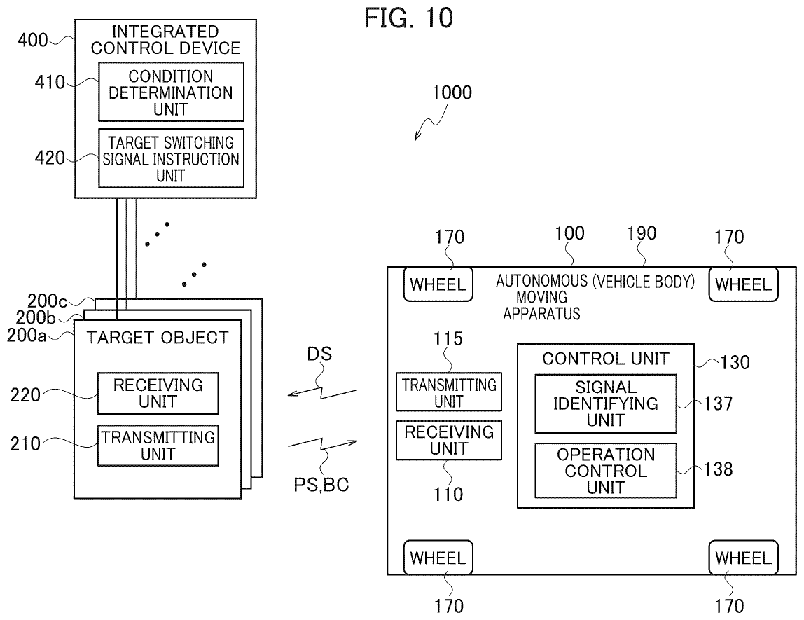

As shown in FIG. 10, the control system according to the sixth embodiment further includes the integrated control device 400 which is communicably connected to each of the plurality of target objects 200. The integrated control device 400 determines whether a position of the autonomous moving apparatus 100 relative to each of the plurality of target objects 200 satisfies the predetermined condition. The integrated control device 400 instructs, a target object 200 in which the relative position of the autonomous moving apparatus 100 is determined to satisfy the predetermined condition, to output the target switching signal BC according to the autonomous moving apparatus 100. As a result, the integrated control device 400 can centrally manage and control the movement of the autonomous moving apparatus 100, instead of the autonomous moving apparatus 100 or the plurality of target objects 200.

The integrated control device 400 may include a condition determination unit 410 and a target switching signal instruction unit 420. The integrated control device 400 receives, from each target object 200, data indicating the strength of the identification signal DS received by the receiving unit 220. The condition determination unit 410 determines whether a position of the autonomous moving apparatus 100 relative to each target object 200 satisfies the predetermined condition, based on at least one of the strength of the received identification signal DS, and the time change of the signal strength. When the condition determination unit 410 determines that the relative position has satisfied the predetermined condition, the target switching signal instruction unit 420 instructs, a target object 200 in which the relative position of the autonomous moving apparatus 100 is determined to satisfy the predetermined condition, to output the target switching signal BC from the transmitting unit 210 thereof. The transmitting unit 210 of the target object 200 which has received the instruction outputs the target switching signal BC. As a result, the control system can cause the autonomous moving apparatus 100 to autonomously move along the appropriate path K4 for reaching the final target object (target object 200d in FIG. 2), while avoiding the obstacles.

Further, the target objects 200 can cooperate with each other by exchanging information via the integrated control device 400. As a result, information on a current position of the autonomous moving apparatus 100 (including proximity information), and identification information of the autonomous moving apparatus 100 (final destination information) can be shared among the plurality of target objects 200. Still further, the integrated control device 400 can store the time required to move between the target objects 200, the number of operators present in the internal space GH, the number of operating autonomous moving apparatuses 100, the task type, time, other environmental factors, and the like. Based on the pieces of information, the integrated control device 400 can perform machine learning or statistical determination, such that the time required for movement, and the number of steps required for movement are reduced, and the integrated control device 400 can optimize the selection or switching order of the target objects 200, or the speed or travel algorithm of the autonomous moving apparatus 100. In addition, a first integrated control device may centrally manage a plurality of target objects 200 arranged in a certain limited area, for example, on the first floor of a building. A second integrated control device may centrally manage a plurality of target objects 200 arranged on the second floor of the same building. In this case, a plurality of integrated control devices may communicate with each other to perform cooperative control.

### Other Embodiments

In the above-described first to sixth embodiments, and the layout example shown in FIG. 2, the target object 200 is a stationary object. However, the target object 200 is not limited thereto, and the target object 200 may be a moving object. The target object 200 may be mounted on the vehicle body 190 of the autonomous moving apparatus 100, for example. This can implement platoon travel of a plurality of autonomous moving apparatuses 100. Due to a person carrying the target object 200, it is possible to cause the autonomous moving apparatus 100 to follow the moving person. The autonomous moving apparatus 100 is guided to the elevator hall using the moving target object 200, for example. In accordance with a door opening operation of the elevator, the target object is switched to a target object installed in the elevator. As a result, the autonomous moving apparatus 100 can be moved into the elevator.

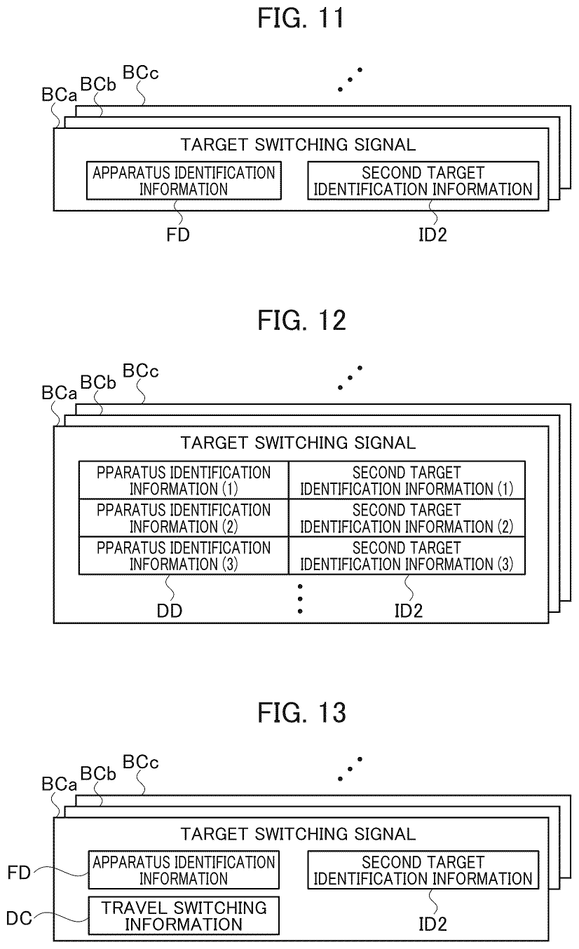

As shown in FIG. 11, each of the plurality of target objects 200 may output the target switching signal BC including identification information FD of the autonomous moving apparatus 100, and the target identification information ID2 for identifying an attraction signal after switching. By causing the signal to include the identification information FD of the autonomous moving apparatus 100, the target object 200 can specify the autonomous moving apparatus 100, and cause the autonomous moving apparatus 100 to switch an attraction signal. When a plurality of autonomous moving apparatuses 100 move simultaneously in the internal space GH shown in FIG. 2, it is possible to instruct only a specific autonomous moving apparatus 100 to switch an attraction signal. Alternatively, it is possible to instruct the autonomous moving apparatus 100 to switch a different attraction signal according to the autonomous moving apparatus 100. As shown in FIG. 13, the target switching signal BC may include the travel switching information DC shown in FIGS. 4 and 8, in addition to the identification information FD and the target identification information ID2.

Alternatively, as shown in FIG. 12, the plurality of target objects 200 may output the target switching signals BC including a plurality of combinations of identification information DD of the autonomous moving apparatus 100, and the target identification information ID2 for identifying an attraction signal after switching which is different according to the autonomous moving apparatus 100. As a result, it is not necessary for the target objects 200 to transmit different target switching signals BC according to the autonomous moving apparatus 100. The target objects 200 can transmit the same target switching signals BC (FIG. 12) to a plurality of autonomous moving apparatuses 100. Each of the autonomous moving apparatuses 100, which has received the target switching signal BC (FIG. 12), can recognize the attraction signal after switching by comparing the identification information DD of the autonomous moving apparatus 100 in question, with the target switching signal BC (FIG. 12).

The control unit 130 shown in FIGS. 3, FIG. 6, FIG. 7, FIG. 9 and FIG. 10, the control unit 230 shown in FIG. 7, the control unit 330 shown in FIG. 9, and the integrated control device 400 shown in FIG. 10 can be implemented using a microcomputer having a Central Processing Unit (CPU), a memory, and an input/output unit. By installing a predetermined computer program in the microcomputer and executing the computer program, the microcomputer constitutes information processing units of the control unit 130, the control unit 230, and the control unit 330, and the microcomputer constitutes the integrated control device 400. Specifically, the control unit 130 constitutes the signal identifying unit 137, the operation control unit 138, and the condition determination unit 139. The control unit 230 constitutes the condition determination unit 231 and the target switching signal output unit 232. The control unit 330 constitutes the condition determination unit 331. It is needless to say that dedicated hardware for executing each information processing may be prepared, or devices such as an application specific integrated circuit (ASIC) and conventional circuit components that are arranged to perform functions may be used.

### (Details of Autonomous Moving Apparatus)

With reference to FIG. 14, the detailed configuration of the autonomous moving apparatus 100 according to the plurality of embodiments will be described. The autonomous moving apparatus 100 includes the receiving unit 110 such as a plurality of antennas, a switch unit 120 for selecting reception elements of the receiving unit 110, the control unit 130, the storage unit 140, an information acquiring unit 150, a drive unit 160, and a moving unit 170. The autonomous moving apparatus 100 may also include a display unit 180A. In addition, basically the moving unit 170 such as a wheel, a belt, a caterpillar, or a propeller is driven by means of drive information output from the drive unit 160 shown in FIG. 14, so that the autonomous moving apparatus 100 moves. The receiving unit 110 has a plurality of reception elements.

The receiving unit 110 is an antenna which receives a radio wave (including high-frequency electromagnetic wave) PS output from the transmitting apparatus 200. The receiving unit 110 may be an array antenna constituted by a plurality of antenna elements, for example. If the receiving unit 110 is the array antenna, an array of the antenna elements constituting the array antenna may be an arbitrary array. The antenna elements may be arranged in line in the traveling direction of the autonomous moving apparatus 100, or in a direction intersecting the traveling direction such as a direction orthogonal to the traveling direction, for example. In addition, it is also possible to arrange the antenna elements so as to form a rectangular shape or an annular shape on a plane not intersecting the traveling direction or on a plane intersecting the traveling direction of the autonomous moving apparatus 100. Further, it is also possible to array the antenna elements in a curved shape. Still further, it is not necessary that the number of the array antenna is one, but the number of array antennas arranged may be more than one, to enhance the accuracy of estimation of an incoming direction of a radio wave and the like. In addition, the receiving unit 110 may be constituted by a plurality of antennas having directivities in different directions. In this case, the plurality of antennas may be arranged in the same manner as the antenna elements of the array antenna. In addition, partition plates made of metal or the like may be disposed to at least one non-directional antenna so as to be able to detect the intensity of a radio wave or a high-frequency electromagnetic wave in a direction surrounded by the partition plates.

The switch unit 120 is a switch configured to select any of the reception elements of the receiving unit 110, and output information on a radio wave or the like received by the reception element. Therefore, the number of switches of the switch unit 120 is equal to the number of the reception elements of the receiving unit 110, and one switch may correspond to one reception element. If the receiving unit 110 is the array antenna, a plurality of antenna elements are selected, and information on the intensity and phase of radio waves received by the plurality of antenna elements is output to a phase difference determining unit 131 and a reception intensity determining unit 132, which will be described later, for example. Further, the switch unit 120 is preferably a semiconductor switch, but the switch unit 120 is not limited thereto, and it is possible to employ a switch which can open and close an electrical connection of any configuration.

The control unit 130 can be implemented using a microcomputer including a CPU and the like. A computer program (autonomous movement program) for causing the microcomputer to function as the control unit 130 is installed in the microcomputer and is executed. As a result, the microcomputer functions as a plurality of information processing units of the control unit 130.

The control unit 130 includes, as the plurality of information processing units, the phase difference determining unit 131, the reception intensity determining unit 132, a reception element selecting unit 133, an angle estimating unit 134, an operation control unit 135, and a contact determining unit 136.

The phase difference determining unit 131 analyzes received signals from the plurality of reception elements of the receiving unit 110 selected by the reception element selecting unit 133 and determines phase differences between the received signals from the differences in arrival times between the received signals. The determined phase differences are output to the angle estimating unit 134. Further, if the autonomous moving apparatus 100 stops or moves, the phase difference determining unit 131 can also determine one angle from the plurality of phase differences between the plurality of received signals.

The reception intensity determining unit 132 determines the reception intensity from the plurality of reception elements of the receiving unit 110 selected by the reception element selecting unit 133. The estimated reception intensity is output to the operation control unit 135. Further, the estimated reception intensity may be output to the reception element selecting unit 133. The reception intensity may be expressed in an arbitrary unit related to the reception intensity and may be expressed as relative information. The reception intensity may be output to the operation control unit 135 and the reception element selecting unit 133 as reception intensity information in any format.

The reception element selecting unit 133 selects elements for receiving radio waves and the like from the plurality of reception elements of the receiving unit 110. It is preferable that the number of reception elements selected is one or more. In order that the phase difference determining unit 131 determines the phase difference, the reception element selecting unit 133 selects a plurality of reception elements. Further, it is possible that the reception element selecting unit 133 selects the reception elements in order, and selects one or more reception elements, in which the reception intensity is determined to be high by the reception intensity determining unit 132. Further, it is possible that the angle estimating unit 134 estimates an incoming direction of a radio wave and the like via the phase difference determining unit 131.

The angle estimating unit 134 can adopt any incoming direction estimation method, such as an estimation method in which a complex reception response to an incoming wave is obtained in advance from the phase difference of several sets of antenna elements, an evaluation function is introduced, and an angle at which an evaluation function value is maximum is set as an incoming direction of a radio wave. Further, the angle estimating unit 134 can estimate an incoming direction of a radio wave from the phase difference of a plurality of antenna elements. A Multiple Signal Classification (MUSIC) and Root-MUSIC method using eigenvalues and eigenvectors of a correlation matrix can be adopted, for example. Further, an Estimation of Signal Parameters via Rotational Invariance Techniques (ESPRIT) method can be adopted. The angle estimated in this way is stored in an angle information storage unit 141 of the storage unit 140 as arbitrary angle information from a reference axis. Still further, the estimated angle information may be stored in the angle information storage unit 141, in association with the reception intensity determined by the reception intensity determining unit 132. Furthermore, the estimated angle information may also be stored in the angle information storage unit 141, in association with the determined reception intensity and time information. The time information may be received by the receiving unit 110 from the outside of the autonomous moving apparatus 100, and the autonomous moving apparatus 100 can perform timing using a timing unit (not shown).

In addition, there may be a plurality of angles estimated by the angle estimating unit 134. If there are a plurality of angles estimated, it is also possible that the angle estimating unit 134 receives the reception intensity at each angle from the reception intensity determining unit 132, associates each angle with the reception intensity, and stores the information in the angle information storage unit 141. If there is an obstacle, a radio wave reflected by the obstacle, and a radio wave propagated on a line-of-sight may be received by the autonomous moving apparatus 100 at different angles, for example. In addition, the radio wave reflected by the obstacle may be further reflected by another obstacle and received by the autonomous moving apparatus 100 at a further different angle. In this way, the reflected wave from the obstacle may reach the autonomous moving apparatus 100 after being reflected multiple times. Basically, the autonomous moving apparatus 100 moves in a direction where the reception intensity is high. However, there is a possibility that an obstacle prevents the autonomous moving apparatus 100 from moving in the direction where the reception intensity is high, or a path is wrong. In this way, there is also a possibility that the autonomous moving apparatus 100 may not avoid moving in a direction of another reflected wave. Therefore, if the plurality of angles are estimated, the autonomous moving apparatus 100 can associate each angle with the reception intensity, and store the information in the angle information storage unit 141.

The operation control unit 135 generates movement direction information including a movement direction for moving the autonomous moving apparatus 100, in response to the magnitude or change of the reception intensity determined by the reception intensity determining unit 132, and an incoming direction of a radio wave estimated by the angle estimating unit 134. In the embodiments, suppose that the operation control unit 135 determines that there is an obstacle or a complicated space in the periphery of the autonomous moving apparatus 100 based on information from the information acquiring unit 150, which will be described later, for example. In the above case, the operation control unit 135 generates the movement direction information, assuming that the reliability of an estimation result by the angle estimating unit 134 and/or a determination result by the reception intensity determining unit 132 is lower than a predetermined reference value. That is, basically, when a reliability index (I) is lower than the predetermined reference value, the operation control unit 135 performs movement control so as to avoid the vicinity thereof.

The operation control unit 135 may generate the movement direction information by performing weighting on an estimated incoming direction of a radio wave according to the reliability, for example. More specifically, the operation control unit 135 may multiply the reception intensity (R) of a plurality of estimated incoming directions of radio waves by the degree of reliability (reliability degree: I), to obtain a product (R*I), and may control the autonomous moving apparatus 100 to move in an incoming direction where the product (R*I) is large. A case is not limited to a case where a plurality of incoming directions of radio waves can be estimated at the same time, but a plurality of incoming directions of radio waves may be compared in the past history. That is, the operation control unit 135 may generate the movement direction information by weighting an incoming direction of a radio wave stored in the storage unit 140, by an index according to the reliability. In addition, if the reliability deteriorates, the operation control unit 135 may control the autonomous moving apparatus 100 to move in a space or direction where the reliability is high.

There are various methods for a method in which the operation control unit 135 determines that the reliability is low, due to the presence of an obstacle or a complicated space in the periphery of the autonomous moving apparatus 100. The operation control unit 135 may determine the reliability based on at least one of the magnitude, the change, the number of reception times, the left-right comparison, and the comparison with the past history of received output information, as well as an estimated distance to an obstacle, the shape of a space, the reception intensity, the amount of noise, and the stability of an incoming direction angle, for example. If the reception intensity determined by the reception intensity determining unit 132 oscillates periodically in an estimated direction, the operation control unit 135 may determine that an obstacle is present in the estimated direction, and lower the reliability, for example. This is because, when the reception intensity oscillates periodically, there is a possibility that an obstacle is present in the periphery of the autonomous moving apparatus 100 or between the autonomous moving apparatus 100 and a target object, and a diffracted wave is received.

In addition, in order for the operation control unit 135 to determine a peripheral obstacle or an intricate and complicated space, the autonomous moving apparatus 100 may include obstacle measuring units for measuring a distance to an obstacle. In the present embodiment, units from the information acquiring unit 150 to the contact determining unit 136 function as the obstacle measuring units. The information acquiring unit 150 may be an infrared sensor, an ultrasonic sensor, or a depth sensor. Furthermore, when the operation control unit 135 receives contact prediction information or contact information from the contact determining unit 136, the operation control unit 135 can determine that the reliability is low, and change the movement direction so as to avoid the obstacle or intricate complicated space. In this case, the changed direction may be maintained temporarily or for a predetermined period of time.

In this way, the operation control unit 135 can associate an index according to the reliability, an incoming direction and the reception intensity of a radio wave, and the history of control contents of the autonomous moving apparatus 100 and store the information in the storage unit 140. The operation control unit 135 can generate movement direction information, in consideration of the time transition of the histories. The operation control unit 135 can associate a movement direction, a movement time or a movement distance in the movement direction, the reliability, and the like, and store the information in a movement direction information storage unit 142. As described above, from the above described information stored in the movement direction information storage unit 142, the operation control unit 135 can calculate the past movement history and generate map information. This enables the autonomous moving apparatus 100 to move by avoiding the periphery of an obstacle or a complicated space with low reliability.

Further, if the radio wave intensity is very low, and if an incoming direction of a radio wave may not be estimated by the angle estimating unit 134, the autonomous moving apparatus 100 including the operation control unit 135 may move, while maintaining the current movement direction. This is because, if a null point occurs due to interference between an emitted radio wave and a reflected radio wave, it may be possible to estimate an incoming direction of a radio wave again by the autonomous moving apparatus 100 moving to another point, for example.

Further, the operation control unit 135 can perform machine learning or deep learning using information such as movement history information, angle information, information on an estimated direction of a radio wave, and reliability, and store machine learning result information or deep learning result information in the storage unit 140. Therefore, the operation control unit 135 causes the storage unit 140 to store the reliability history according to the reliability and movement direction information as teaching data. Still further, the machine learning result information or deep learning result information can be stored in the storage unit 140, in association with the information such as the movement direction information, angle information, information on an estimated direction of a radio wave, and reliability.

The contact determining unit 136 determines whether there is a possibility that the autonomous moving apparatus 100 contacts an obstacle, based on information acquired by the information acquiring unit 150. After the information acquiring unit 150 detects the obstacle, the information acquiring unit 150 transmits information on the detected obstacle to the contact determining unit 136. The contact determining unit 136 transmits contact prediction information to the operation control unit 135, if the contact determining unit 136 expects that the autonomous moving apparatus 100 contacts the obstacle, based on the movement direction and size of the autonomous moving apparatus 100, and the obtained information on the obstacle. Further, the contact determining unit 136 transmits contact information to the operation control unit 135, if the contact determining unit 136 determines that the autonomous moving apparatus 100 contacts the obstacle.

The storage unit 140 is a computer-readable storage medium. The storage unit 140 may be a Read Only Memory (ROM) or an Erasable Programmable ROM (EPROM), for example. Further, the storage unit 140 may be an Electrically Erasable Programmable ROM (EEPROM), a Random Access Memory (RAM), a hard disk, or the like.

The storage unit 140 includes the angle information storage unit 141, the movement direction information storage unit 142, and a reception intensity information storage unit 143.

The angle information storage unit 141 stores angle information of a radio wave of which an incoming direction is estimated by the angle estimating unit 134. The angle information may be information from a predetermined reference axis, which may be based on a physical outline of the autonomous moving apparatus 100. The outline may be expressed in two-dimensional relative coordinates other than a space in which the autonomous moving apparatus 100 moves, and a line expressed by the relative coordinates may be used as the reference axis, for example. The angle information may be stored, in association with estimated radio wave reception intensity information and time information at which the angle information is estimated. This is because, in the predetermined case described above, angle information other than angle information in which the reception intensity is the highest may be used, and it may be necessary to compare the information with the past angle information. In addition, the angle information may represent an angle changed from a first determined angle and may be stored in such a way that it is easy to create map information.

The movement direction information storage unit 142 can store information on a movement direction which is determined by the operation control unit 135, and in which the autonomous moving apparatus 100 actually moves, in association with time information at which movement of the autonomous moving apparatus 100 in the movement direction starts, and time information at which the movement of the autonomous moving apparatus 100 in the movement direction ends. In addition, the time information at which the movement of the autonomous moving apparatus 100 in the movement direction starts, or the time information at which the movement of the autonomous moving apparatus 100 in the movement direction ends, and time information at which the autonomous moving apparatus 100 is moving in the movement direction may be stored in the movement direction information storage unit 142, in association with the movement direction information. The operation control unit 135 may reproduce the past movement path of the autonomous moving apparatus 100 based on the pieces of information. In order that the autonomous moving apparatus 100 may reach a target object, the operation control unit 135 can select a path which prevents the autonomous moving apparatus 100 from travelling along the same movement path, with reference to the past movement path. Further, the contact determining unit 136 may also estimate a position of an obstacle with reference to the past movement path. In addition, the control unit 130 may perform machine learning or deep learning, and the storage unit 140 including the movement direction information storage unit 142 may store machine learning result information or deep learning result information. Further, the machine learning result information or deep learning result information may be stored, in association with the information such as the movement direction information, angle information, information on an estimated direction of a radio wave, and reliability.

The reception intensity information storage unit 143 stores reception intensity information of radio waves received by a plurality of reception elements, the information being determined by the reception intensity determining unit 132. Further, the reception intensity information storage unit 143 stores the reception intensity of the radio waves received by the plurality of reception elements in an estimated radio wave incoming direction. Still further, the reception intensity information may be stored in the reception intensity information storage unit 143, in association with time information at which the reception intensity is determined.

The drive unit 160 includes a mechanism for driving the moving unit 170 to move the autonomous moving apparatus 100 in a movement direction determined by the operation control unit 135. The drive unit 160 includes a mechanism for rotating a wheel, if the moving unit 170 is the wheel, a mechanism for turning a caterpillar, if the moving unit 170 is the caterpillar, and a mechanism for rotating a propeller, if the moving unit 170 is the propeller, for example. The drive unit 160 is not limited to the above aspects, but the drive unit 160 can have any driving configuration which drives a configuration of the moving unit 170.

The moving unit 170 is a portion constituting means for moving the autonomous moving apparatus 100. If the autonomous moving apparatus 100 is a vehicle, the moving unit 170 may be a wheel including a tire, a caterpillar, or the like. Further, if the autonomous moving apparatus 100 is a flying object such as a drone or a helicopter, the moving unit 170 may be a propeller. The moving unit 170 is not limited to the above aspects, but the moving unit 170 can have any moving mechanism capable of moving the autonomous moving apparatus 100.

The display unit 180A can optionally be attached to the autonomous moving apparatus 100 or installed in a monitor space separated from the autonomous moving apparatus 100, to enable a user to confirm image information in a movement direction of the autonomous moving apparatus 100. In this way, it is also possible for the user to confirm whether the autonomous moving apparatus 100 is moving normally by confirming the image information output to the display unit 180A.

### Seventh Embodiment

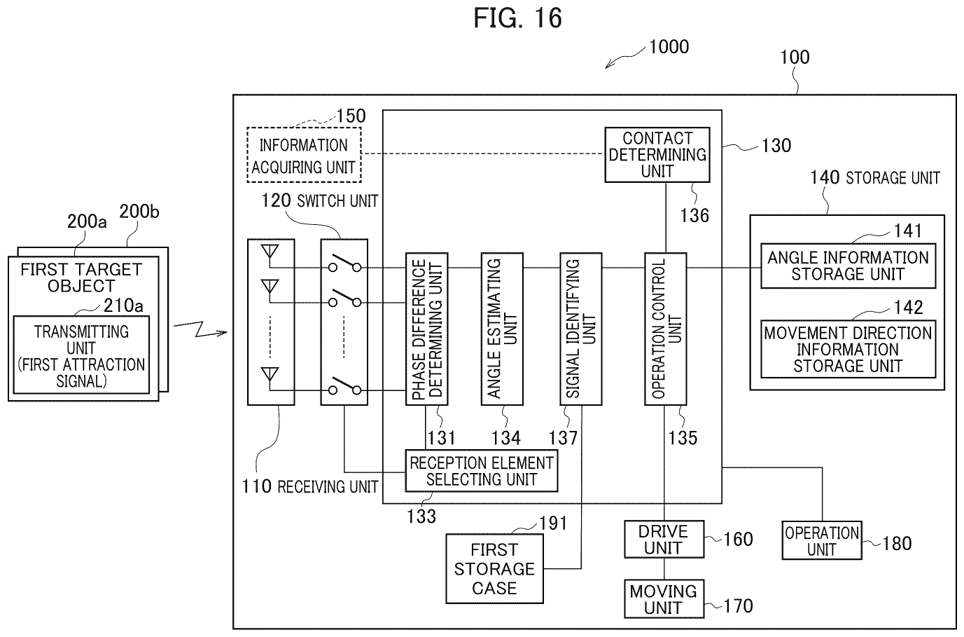

With reference to FIG. 16, the configuration of the autonomous movement system 1000 and the autonomous moving apparatus 100 according to a seventh embodiment will be described. Here, the differences between the seventh embodiment and the first to sixth embodiments will be described mainly, and duplicated descriptions of the configuration which is the same as the configuration of the autonomous movement system 1000 and the autonomous moving apparatus 100 described with reference to FIG. 14 will be omitted.

The autonomous movement system 1000 includes the autonomous moving apparatus 100, the first target object 200a which emits the first attraction signal, and the second target object 200b which emits the second attraction signal. The autonomous moving apparatus 100 autonomously moves based on an incoming direction of an attraction signal. The attraction signal includes the first attraction signal and the second attraction signal. The autonomous moving apparatus 100 includes the receiving unit 110 which receives signals output from a target object, the signal identifying unit 137 which identifies an attraction signal among the received signals, and the operation control unit 135 which causes the autonomous moving apparatus 100 to move, based on an incoming direction of the identified attraction signal. The target object includes the first target object 200a and the second target object 200b. The signal identifying unit 137 identifies the first attraction signal output from the moving first target object 200a. The operation control unit 135 causes the autonomous moving apparatus 100 to move, based on an incoming direction of the identified first attraction signal. Then, the signal identifying unit 137 switches an attraction signal to be identified from the first attraction signal to the second attraction signal output from the stationary second target object 200b, and identifies the second attraction signal. The operation control unit 135 causes the autonomous moving apparatus 100 to move, based on an incoming direction of the identified second attraction signal.

An attraction signal identified by the signal identifying unit 137 is set to the first attraction signal output from the moving first target object 200a. Since a moving target of the autonomous moving apparatus 100 can be set to a moving object (first target object 200a), it is possible to cause the autonomous moving apparatus 100 to follow the moving object. Thereafter, an attraction signal identified by the signal identifying unit 137 is switched from the first attraction signal to the second attraction signal output from the stationary second target object 200b. As a result, the moving target of the autonomous moving apparatus 100 can be switched to the stationary object (second target object 200b), and therefore it is possible to cause the autonomous moving apparatus 100 to autonomously move to a place where the stationary object is located. By switching the target object and the attraction signal in this way, a following movement and an autonomous movement can be implemented using the same apparatus (autonomous moving apparatus 100). Therefore, it is not necessary to switch between a following traveling algorithm and an autonomous traveling algorithm which are different from each other, and it is not necessary to introduce both a following mobile robot and an autonomous mobile robot as in the past.

In the embodiment, the moving first target object 200a itself may be a moving object, may be a form such as an IC tag or an electronic tag which can be carried by a human, or may be a form which can be attached to and detached from a moving object. In accordance with the movement of a human carrying the first target object 200a or a moving object to which the first target object 200a is attached, the first target object 200a moves. The first target object 200a includes a transmitting unit 210a which outputs the first attraction signal. The second target object 200b includes a transmitting unit 210b which outputs the second attraction signal.

Specific examples of attraction signals include radio waves and high-frequency electromagnetic waves. An attraction signal received by the receiving unit 110 includes ID information (first target identification information ID1) specific to each of the attraction signals PSa, PSb, PSc, and so forth as shown in FIG. 4 and FIG. 5, for example. The signal identifying unit 137 reads the ID information included in the attraction signal received by the receiving unit 110 and identifies an attraction signal having specific ID information. In other words, the signal identifying unit 137 identifies a specific attraction signal, based on the ID information included in the attraction signal received by the receiving unit 110. The signal identifying unit 137 can switch an attraction signal to be identified, between the first attraction signal and the second attraction signal by switching ID information of the attraction signal to be identified. Although the seventh embodiment shows the autonomous movement system 1000 including two types of attraction signals, and two target objects, which are the target object 200a and the target object 200b, the number of target objects may be three or more, and the number of types of attraction signals may be three or more. In this case, the signal identifying unit 137 switches an attraction signal to be identified between the three attraction signals. As a specific method for switching an attraction signal, the method described in the first to sixth embodiments can be used.

The signal identifying unit 137 identifies an incoming direction of a radio wave having specific ID information, that is, an angle, among incoming directions (angles) of radio waves estimated by the angle estimating unit 134. The ID information included in the radio wave, is associated with data indicating the incoming direction of the radio wave estimated by the angle estimating unit 134. The signal identifying unit 137 identifies the incoming direction of the radio wave having the specific ID information, using the associated ID information. The data indicating the identified incoming direction of the radio wave is transmitted to the operation control unit 135.

The operation control unit 135 generates movement direction information including a movement direction for moving the autonomous moving apparatus 100, in response to the incoming direction of the radio wave identified by the signal identifying unit 137. As has been described with reference to FIG. 14, the operation control unit 135 may associate an index according to the reliability, an incoming direction and the reception intensity of a radio wave, and the history of control contents of the autonomous moving apparatus 100 and store the information in the storage unit 140. The operation control unit 135 may generate the movement direction information, in consideration of the time transition of the histories.

As in FIG. 14, the storage unit 140 includes the angle information storage unit 141, and the movement direction information storage unit 142.

The operation unit 180 receives an input operation performed by a user of the autonomous moving apparatus 100. The operation unit 180 is a touch panel which can display image information indicating the control state of the autonomous moving apparatus 100, for example. The user of the autonomous moving apparatus 100 can switch an attraction signal identified by the signal identifying unit 137 using the operation unit 180. Further, if the operation unit 180 is the touch panel, the user can confirm whether the autonomous moving apparatus 100 is moving normally by confirming the image information. The user can also confirm an attraction signal (radio wave) or target object to be identified at present.

The autonomous moving apparatus 100 may also have, as a part of the information acquiring unit 150, a short distance measuring sensor, a depth camera, or a stereo camera for preventing contact with an obstacle that appears in the immediate vicinity (for example, within 50 cm), and a bumper sensor or a contact sensor for detecting collision with an obstacle. When the autonomous moving apparatus 100 is applied to an automatic guided vehicle, it is needless to say that the autonomous moving apparatus 100 has a function that satisfies the provision related to ISO3691-4/JIS D 6802 “Automatic guided vehicles and systems-Safety requirements and verification” related to the safety of an automatic guided vehicle.

### Example 1

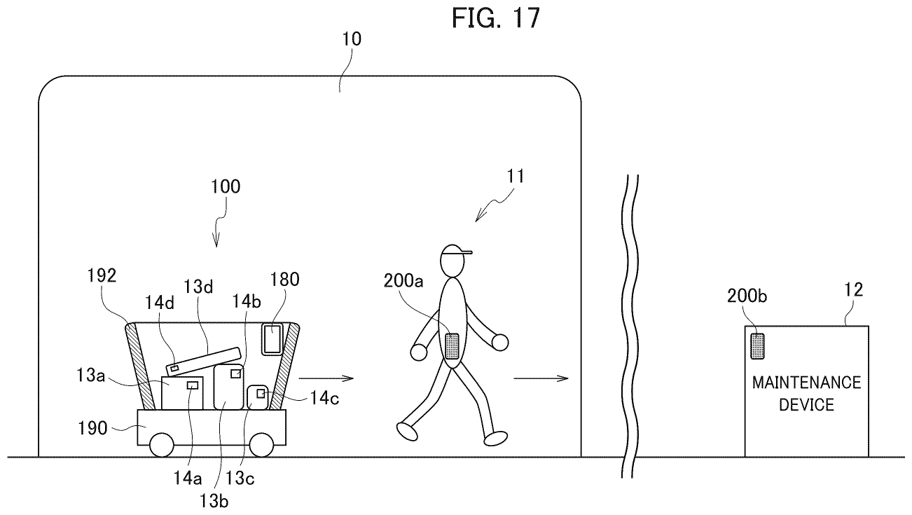

As Example 1 of the seventh embodiment, a description will be given regarding an example in which an attraction signal to be identified is switched by the user performing a switching operation, with reference to FIG. 17. FIG. 17 is a schematic diagram showing an example of a use scene according to Example 1 of the seventh embodiment. FIG. 17 shows a use scene in which the autonomous movement system 1000 is introduced in the maintenance of a machine such as production equipment in a factory. The machine to be maintained is a maintenance device 12. Articles such as screws, tools, cleaning fluids, and inspection equipment necessary for maintaining the maintenance device 12 are stored in a warehouse 10 away from the maintenance device 12. The autonomous moving apparatus 100 has a second storage case 192 which can store the articles necessary for maintenance. The second storage case 192 is attached on the vehicle body 190 which is a part of the autonomous moving apparatus 100. The touch panel as the operation unit 180 is attached at an upper portion of the second storage case 192.

An operator 11 performing maintenance as an example of the user carries the portable first target object 200a. When the operator 11 moves, the autonomous moving apparatus 100 follows the moving operator 11, based on an incoming direction of the first attraction signal output from the first target object 200a. In other words, the autonomous moving apparatus 100 performs following movement. While moving in the warehouse 10, the operator 11 stores, in the second storage case 192, one or more articles 13a, 13b, 13c, and 13d which are necessary for maintaining the maintenance device 12. The operator 11 moves in the warehouse, while the autonomous moving apparatus 100 following the operator 11, and the operator 11 collects the articles 13a to 13d scattered in the warehouse in the second storage case 192. When the operator 11 determines that all the articles necessary for maintaining the maintenance device 12 are stored in the second storage case 192, the operator 11 operates the operation unit 180 to perform a switching operation for switching an attraction signal from the first attraction signal to the second attraction signal. After the signal identifying unit 137 shown in FIG. 16 receives from the operator 11, the switching operation for switching an attraction signal from the first attraction signal to the second attraction signal, the signal identifying unit 137 switches an attraction signal to be identified from the first attraction signal to the second attraction signal.

The attachable/detachable second target object 200b is attached in advance to the maintenance device 12 to be maintained. Alternatively, a part of the maintenance device 12 may be the second target object 200b. The signal identifying unit 137 shown in FIG. 16 identifies the second attraction signal output from the second target object 200b, and the operation control unit 135 causes the autonomous moving apparatus 100 to move, based on an incoming direction of the second attraction signal. The autonomous moving apparatus 100 autonomously moves to a place where the maintenance device 12 as a stationary object is located, based on the incoming direction of the second attraction signal output from the stationary second target object 200b. In other words, the autonomous moving apparatus 100 performs autonomous movement.

In Example 1, it is not necessary to electrically connect the first target object 200a carried by the operator 11 to the autonomous moving apparatus 100, in order to switch an attraction signal from the first attraction signal to the second attraction signal. That is, it is not necessary to return the first target object 200a to the autonomous moving apparatus 100, and the first target object 200a can be associated with the operator 11. Example 1 is suitable for a use scene in which it is not necessary to inhibit the user from taking home the first target object 200a, and only a managed specific user (operator 11) is targeted.

The operation control unit 135 moves the vehicle body, while keeping the distance between a person holding the first target object 200a (operator 11), and the autonomous moving apparatus 100 constant. The operation control unit 135 can estimate the distance between the operator 11 and the autonomous moving apparatus 100, based on movement direction information generated by the operation control unit 135. That is, the autonomous moving apparatus 100 continuously moves toward a direction of the operator 11 at an incoming angle of a radio wave, and the autonomous moving apparatus 100 measures the distance between the autonomous moving apparatus 100 and the operator 11, based on an arrival time of a radio wave. Therefore, the operation control unit 135 moves the autonomous moving apparatus 100, such that the reception intensity of a radio wave coming from the movement direction of the autonomous moving apparatus 100 is constant. This makes it possible for the autonomous moving apparatus 100 to perform following movement, while keeping a constant distance.

The operation control unit 135 measures the distance between the operator 11 and the autonomous moving apparatus 100 using a reflected wave of a laser, an acoustic wave, or a radio wave from an object. The distance between the operator 11 and the autonomous moving apparatus 100 can be estimated using a reflected wave of a laser, an acoustic wave, or a radio wave emitted toward the movement direction from the autonomous moving apparatus 100, the reflected wave being reflected from the operator 11 as an obstacle.

### Modified Example 1

As Modified Example 1 of Example 1, an example will be described, in which radio frequency identifications (RFIDs) attached to articles are used to determine that all the articles necessary for maintaining the maintenance device 12 are stored in the second storage case 192. The autonomous moving apparatus 100 has the second storage case 192 which can store the articles. The signal identifying unit 137 switches an attraction signal from the first attraction signal to the second attraction signal, when all predetermined articles are stored in the second storage case 192. The “predetermined articles” in Modified Example 1 refer to articles necessary for maintaining the maintenance device 12. The signal identifying unit 137 determines that all the predetermined articles 13a to 13d are stored in the second storage case 192 using RFIDs 14a to 14d attached to the articles 13a to 13d, respectively, as shown in FIG. 17, for example. The autonomous moving apparatus 100 may include an RFID reader for reading the RFIDs 14a to 14d attached to the articles stored in the second storage case 192, for example. Alternatively, the autonomous movement system 1000 may include an RFID reader located in the warehouse 10. Articles required for maintaining the maintenance device 12 are determined in advance. Therefore, the autonomous movement system 1000 can determine whether all articles are collected using the RFID reader. This eliminates the necessity of the determination made by the operator 11, and a switching operation to the operation unit 180. As a result, the user's convenience is enhanced. Further, it is not necessary to dispose the operation unit 180, and the cost of the autonomous moving apparatus 100 is reduced. Two-dimensional codes or one-dimensional codes may be attached to the articles 13a to 13d, instead of attaching the RFIDs 14a to 14d. In this case, the autonomous movement system 1000 may have a camera or a reader for recognizing the two-dimensional codes or one-dimensional codes, instead of the RFID reader.

### Example 2

As Example 2 of the seventh embodiment, an example will be described, in which an attraction signal to be identified is switched, due to an electrical connection between the autonomous moving apparatus 100 and the first target object 200a. As shown in FIG. 16, the autonomous moving apparatus 100 may further include a first storage case 191 which can store the first target object 200a. The first target object 200a is a form which can be carried by a human or is a form which can be attached to and detached from a moving object. Although not shown in FIG. 16, the autonomous moving apparatus 100 is configured to be electrically connected to the first target object 200a stored in the first storage case 191 in a wireless or wired manner. The autonomous moving apparatus 100 may have, in the first storage case 191, an electric cable which can be electrically connected to the first target object 200a, for example. In this case, the user stores the first target object 200a in the first storage case 191 and connects a terminal of the electric cable to the first target object 200a. As a result, the autonomous moving apparatus 100 and the first target object 200a are electrically connected in a wired manner.

Alternatively, the autonomous moving apparatus 100 may have an RFID reader which can be connected to the first target object 200a stored in the first storage case 191 in a non-contact manner. In this case, the first target object 200a has an RFID. Due to the user merely storing the first target object 200a in the first storage case 191, the RFID reader recognizes the RFID in the first target object 200a. As a result, the autonomous moving apparatus 100 and the first target object 200a are electrically connected in a wireless manner. This eliminates the necessity of an electric cable, and an attachment and detachment operation between the electric cable and the first target object 200a, which is performed by the user. Due to the first target object 200a being stored in the first storage case 191, the first target object 200a is electrically connected to the autonomous moving apparatus 100. Due to the first target object 200a being taken out of the first storage case 191, the electrical connection between the first target object 200a and the first storage case 191 is released. This saves the user's time required for connecting the terminal of the electric cable to the first target object 200a. As a result, the user's convenience is enhanced.

The signal identifying unit 137 switches an attraction signal to be identified, between the first attraction signal and the second attraction signal, depending on whether the autonomous moving apparatus 100 and the first target object 200a are electrically connected. This enables switching between the following movement and the autonomous movement, depending on whether there is an electrical connection. Specifically, when the autonomous moving apparatus 100 and the first target object 200a are not electrically connected, the signal identifying unit 137 sets an attraction signal to be identified to the first attraction signal. Alternatively, when the autonomous moving apparatus 100 and the first target object 200a are electrically connected, the signal identifying unit 137 sets an attraction signal to be identified to the second attraction signal. Further, since it is possible to prompt the user to return the first target object 200a, it is possible to inhibit the user from taking home the first target object 200a. Example 2 is suitable for a use scene in which, it is necessary to inhibit the user from taking home the first target object 200a, and unspecified large number of users who are not managed are targeted.

An example of a use scene of Example 2 is an article purchase scene in a retail store such as a department store, a supermarket, a convenience store, or an electronics retail store. The interior of a retail store where articles are displayed corresponds to the warehouse 10 shown in FIG. 17. A cart which stores articles that a customer wants to purchase in the retail store corresponds to the autonomous moving apparatus 100 shown in FIG. 17. In the article purchase scene, the second target object 200b is not arranged in the maintenance device 12 of FIG. 17, but the second target object 200b is arranged at a place where a used cart is returned, that is, a cart corral. The autonomous moving apparatus 100 includes the second storage case 192 which stores an article, and the first storage case 191 which can store the first target object 200a, instead of the operation unit 180 of FIG. 16 or FIG. 17.

First, the customer takes out the first target object 200a from the first storage case 191 of a cart (autonomous moving apparatus 100) in a cart corral at a store entrance or a parking lot added to the store and carries the first target object 200a. Then, the electrical connection between the first target object 200a and the autonomous moving apparatus 100 is released. Therefore, an attraction signal to be identified of the signal identifying unit 137 is switched from the second attraction signal to the first attraction signal. Accordingly, the autonomous moving apparatus 100 starts following the customer who carries the first target object 200a. That is, the autonomous moving apparatus 100 starts the following movement.

The customer puts an article that the customer wants to purchase in the store, into the second storage case 192, and performs a purchase procedure of the article. After the end of the purchase procedure, the customer takes the purchased article out of the second storage case 192 and stores the first target object 200a in the first storage case 191. Then, the first target object 200a is electrically connected to the autonomous moving apparatus 100. Therefore, an attraction signal to be identified of the signal identifying unit 137 is switched from the first attraction signal to the second attraction signal. Therefore, the autonomous moving apparatus 100 starts autonomously moving to the cart corral where the second target object 200b is placed, based on the incoming direction of the second attraction signal. That is, the autonomous moving apparatus 100 starts the autonomous movement. During shopping, since the customer carries the first target object 200a, the electrical connection between the first target object 200a and the autonomous moving apparatus 100 is released. The autonomous moving apparatus 100 follows the moving first target object 200a (customer).

After the end of the shopping, the first target object 200a which has been carried until now by the customer is stored in the first storage case 191, and then the first target object 200a is electrically connected to the autonomous moving apparatus 100. Since the first target object 200a is electrically connected to the autonomous moving apparatus 100, the autonomous moving apparatus 100 moves autonomously toward the stationary second target object 200b (cart corral). Example 2 can inhibit a user who has finished shopping from taking home the first target object 200a. It is possible to prompt the user who has finished shopping to return the first target object 200a.

### Modified Example 2

As Modified Example 2 of Example 2, an example will be described, in which the autonomous movement system 1000 determines that all articles stored in the second storage case 192 are removed from the second storage case 192, after the end of a purchase procedure of the article, using RFIDs attached to the articles. The autonomous moving apparatus 100 has the second storage case 192 which can store the articles. RFIDs are attached in advance to articles which can be purchased in the store. The customer puts articles that the customer wants to purchase into the second storage case 192 of the autonomous moving apparatus 100 following the customer. After the customer finishes putting all the articles that the customer wants to purchase into the second storage case 192, the customer passes a settlement gate for preforming a purchase procedure using RFIDs. An RFID reader which can read an RFID attached to an article is installed in the settlement gate in advance. The RFID reader reads RFIDs of all the articles stored in the second storage case 192, and the purchase procedure of the articles is performed. Purchase completion information indicating that the purchase has been completed may be attached to the RFIDs of the articles for which the purchase procedure has been completed.

After passing the settlement gate, the customer causes the autonomous moving apparatus 100 to perform the following movement to a vehicle of the customer parked in a parking lot added to the store, for example. Then, the customer moves all the purchased articles from the second storage case 192 into a vehicle trunk. As in Modified Example 1, the autonomous moving apparatus 100 may include an RFID reader which reads the RFIDs attached to the articles stored in the second storage case 192. The autonomous moving apparatus 100 can determine whether all the purchased articles are removed from the second storage case 192 using the RFID reader. It is needless to say that the RFID reader may be installed in the parking lot, instead of the autonomous moving apparatus 100. In this way, the autonomous movement system 1000 can determine that all the articles stored in the second storage case 192 are removed from the second storage case 192, after the end of the purchase procedure of the article, using the RFIDs attached to the articles. This eliminates the necessity of a switching operation to the operation unit 180 performed by the customer, and user's convenience is enhanced. It is not necessary to dispose the operation unit 180, and the cost of the autonomous moving apparatus 100 is reduced.

In Modified Example 2, as in Example 2, the first target object 200a being stored in the first storage case 191 may be added to conditions for switching a target object from the first target object 200a to the second target object 200b. That is, the autonomous movement system 1000 may switch a target object from the first target object 200a to the second target object 200b, only when both of the following conditions (1) and (2) are satisfied. As a result, it is possible to prompt a user who has finished shopping to return the first target object 200a. (1) After the end of a purchase procedure of articles stored in the second storage case 192 using RFIDs attached to the articles, all the articles were removed from the second storage case 192. (2) The first target object 200a was stored in the first storage case 191.

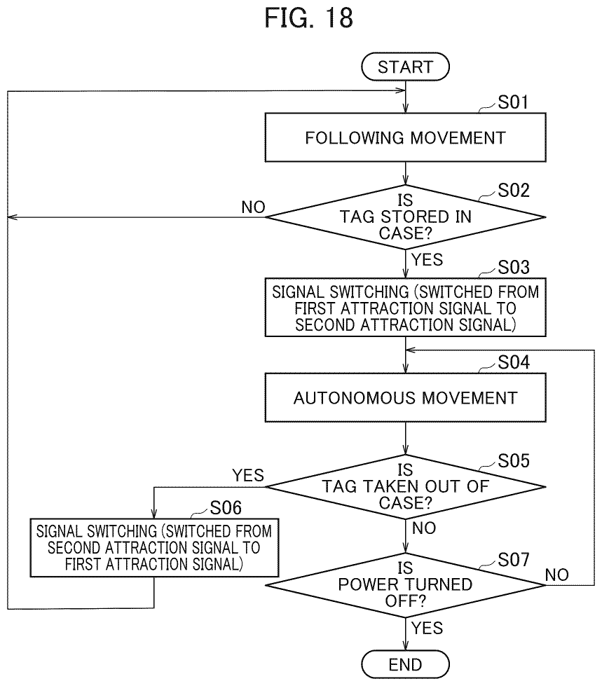

With reference to FIG. 18, a description will be given regarding the flow of an operation performed by the autonomous moving apparatus 100 in Example 2 described above. FIG. 18 is a flowchart which starts by using, as a trigger, switching of an attraction signal identified by the signal identifying unit 137, from the second attraction signal to the first attraction signal. That is, the flowchart shown in FIG. 18 starts due to the customer taking out the first target object 200a from the first storage case 191 in the article purchase scene of Example 2. A “tag” shown in FIG. 18 corresponds to the first target object 200a. A “case” shown in FIG. 18 corresponds to the first storage case 191.

By switching an attraction signal to the first attraction signal, in step S01, the autonomous moving apparatus 100 starts following a customer who carries the first target object 200a (tag). The following movement in step S01 continues, until the first target object 200a is returned to the first storage case 191. After the end of a purchase procedure, the customer takes out a purchased article from the second storage case 192 and stores the first target object 200a in the first storage case 191. An answer to the determination in step S02 is YES, and the processing proceeds to step S03. In step S03, the first target object 200a is electrically connected to the autonomous moving apparatus 100. Therefore, an attraction signal to be identified of the signal identifying unit 137 is switched from the first attraction signal to the second attraction signal.

The processing proceeds to step S04, and in step S04, the autonomous moving apparatus 100 starts moving autonomously to a cart corral where the second target object 200b is placed, based on the incoming direction of the second attraction signal. That is, the autonomous moving apparatus 100 starts the autonomous movement. The autonomous movement in step S04 continues, until the autonomous moving apparatus 100 arrives at the cart corral. Thereafter, the processing proceeds to step S05, and a new customer starts using the autonomous moving apparatus 100 returned to the cart corral. That is, the new customer takes out the first target object 200a stored in the first storage case 191 and carries the first target object 200a (YES in step S05). The processing proceeds to step S06, and in step S06, an attraction signal is switched from the second attraction signal to the first attraction signal, and the processing returns to step S01. If the power of the autonomous moving apparatus 100 in the cart corral is turned off (YES in step S07), the flowchart of FIG. 18 ends.

Although the present disclosure has been described in detail above, it will be obvious to those skilled in the art that the present disclosure is not limited to the embodiments described in the present disclosure. One or more elements of one embodiment may be combined with one or more elements of another embodiment. The present disclosure can be implemented as modifications and variations without departing from the spirit and scope of the present disclosure as defined by the claims. Therefore, the description of the present disclosure is for the purpose of illustration and does not have any restrictive meaning to the present disclosure.

### (Supplementary Notes)

### (Supplementary Note 1: First Embodiment, FIG. 1)

Provided is an autonomous moving apparatus 100 including: a receiving unit 110 that is attached to a moving object and receives signals PS and AS output from a target object 200; a signal identifying unit 137 that identifies an attraction signal PS from the received signals PS and AS; and an operation control unit 138 that causes the moving object to move, based on an incoming direction of the identified attraction signal PS, in which the signal identifying unit 137 identifies a first attraction signal PSa that is output from a first target object 200a as the attraction signal PS, the operation control unit 138 causes the moving object to move, based on an incoming direction of the first attraction signal PSa, when a position of the moving object relative to the first target object 200a satisfies a predetermined condition, the signal identifying unit 137 switches an attraction signal from the first attraction signal PSa to a second attraction signal PSb that is output from a second target object 200b, and identifies the second attraction signal PSb as the attraction signal, and the operation control unit 138 causes the moving object to move, based on an incoming direction of the second attraction signal PSb.

### (Supplementary Note 2: First Embodiment, FIG. 3)

Provided is the autonomous moving apparatus 100 according to Supplementary note 1 further including: a storage unit 140 that stores data in which the order of the first attraction signal PSa and the second attraction signal PSb identified by the signal identifying unit 137 is determined, in which the signal identifying unit 137 switches an attraction signal according to the order stored in the storage unit.

### (Supplementary Note 3: Second Embodiment, FIG. 5)

Provided is the autonomous moving apparatus 100 according to Supplementary note 1, in which the first attraction signal PSa includes first target identification information ID1 used by the signal identifying unit 137 to identify the first attraction signal PSa, and second target identification information ID2 used by the signal identifying unit 137 to identify the second attraction signal PSb. The signal identifying unit 137 switches an attraction signal from the first attraction signal PSa to the second attraction signal PSb based on the second target identification information ID2 included in the first attraction signal PSa.

### (Supplementary Note 4: First Embodiment, FIG. 4)

Provided is the autonomous moving apparatus 100 according to any one of Supplementary notes 1 to 3, in which the first attraction signal PSa includes travel switching information DC for switching at least one element of a movement and a temporary stop, a movement speed, and a travel algorithm of the autonomous moving apparatus 100. The operation control unit 138 switches at least one element of a movement and a temporary stop, a movement speed, and a travel algorithm of the autonomous moving apparatus 100 based on the travel switching information DC.

### (Supplementary Note 5: First Embodiment)

Provided is the autonomous moving apparatus 100 according to any one of Supplementary notes 1 to 4 further including: a condition determination unit 139 that determines whether the position of the moving object relative to the first target object 200a satisfies the predetermined condition, based on at least one of signal strength of the first attraction signal PSa received by the receiving unit 110, and a time change rate of the signal strength.

### (Supplementary Note 6: First Embodiment)

Provided is the autonomous moving apparatus 100 according to any one of Supplementary notes 1 to 5, in which the signal identifying unit 137 identifies an avoiding signal AS from the received signals PS and AS, and the operation control unit 138 causes the moving object to move in a direction where strength of the avoiding signal AS decreases, based on the incoming direction of the identified attraction signal PS.

### (Supplementary Note 7: Third Embodiment)

Provided is the autonomous moving apparatus 100 according to any one of Supplementary notes 1 to 6 further including: a transmitting unit 115 that transmits an identification signal DS including information for identifying the autonomous moving apparatus 100 in question from another autonomous moving apparatus 100, and information indicating priority of the autonomous moving apparatus 100 in question with the other autonomous moving apparatus 10. The signal identifying unit 137 identifies the identification signal DS output from the other autonomous moving apparatus 100, from the received signals, and the operation control unit 138 controls an operation of the autonomous moving apparatus 100 in question relative to the other autonomous moving apparatus 100 based on the priority, when a position of the moving object relative to the other autonomous moving apparatus 100 satisfies the predetermined condition.

### (Supplementary Note 8: Fourth Embodiment)

Provided is a control system for controlling an autonomous moving apparatus 100 that includes a receiving unit 110 which receives signals PS and BC, that identifies an attraction signal PS from the received signals PS and BC, and that moves based on an incoming direction of the identified attraction signal PS, the control system including: a plurality of target objects 200 that output mutually different attraction signals PS. The plurality of target objects 200 output a target switching signal BC for causing the autonomous moving apparatus 100 to switch an attraction signal PS to be identified, when a relative position of the autonomous moving apparatus 100 satisfies a predetermined condition.

### (Supplementary Note 9: Fifth Embodiment)

Provided is the control system according to Supplementary note 8 further including: a plurality of target switching devices 300 that output the target switching signal BC, when the relative position of the autonomous moving apparatus 100 satisfies the predetermined condition.

### (Supplementary Note 10: Fifth Embodiment)

Provided is the control system according to Supplementary note 8 or 9, in which the target switching signal BC includes travel switching information DC for switching at least one element of a movement and a temporary stop, a movement speed, and a travel algorithm of the autonomous moving apparatus 100.

### (Supplementary Note 11: Other Embodiments)

Provided is the control system according to any one of Supplementary notes 8 to 10, in which the target objects 200 are moving objects.

### (Supplementary Note 12: Fourth Embodiment)

Provided is the control system according to any one of Supplementary notes 8 to 11, in which each of the plurality of target objects 200 includes: a receiving unit 220 that receives an identification signal DS output from the autonomous moving apparatus 100; and a condition determination unit 231 that determines whether the relative position of the autonomous moving apparatus 100 satisfies the predetermined condition, based on at least one of signal strength of the identification signal DS received by the receiving unit 220, and a time change of the signal strength.

### (Supplementary Note 13: Sixth Embodiment)

Provided is the control system according to any one of Supplementary notes 8 to 12 further including: an integrated control device 400 that is communicably connected to each of the plurality of target objects 200. The integrated control device 400 determines whether a position of the autonomous moving apparatus 100 relative to each of the plurality of target objects 200 satisfies the predetermined condition. The integrated control device 400 instructs, a target object 200 in which the relative position of the autonomous moving apparatus 100 is determined to satisfy the predetermined condition, to output the target switching signals BC according to the autonomous moving apparatus 100.

### (Supplementary Note 14: Other Embodiments, FIG. 11 and FIG. 13)

Provided is the control system according to any one of Supplementary notes 8 to 13, in which the plurality of target objects 200 output a target switching signal BC including identification information FD of the autonomous moving apparatus 100, and target identification information ID2 for identifying an attraction signal after switching.

### (Supplementary Note 15: Other Embodiments, FIG. 12)

Provided is the control system according to any one of Supplementary notes 8 to 13, in which the plurality of target objects 200 output a target switching signal BC including a plurality of combinations of identification information DD of the autonomous moving apparatus 100, and target identification information ID2 for identifying an attraction signal after switching that is different according to the autonomous moving apparatus 100.

### (Supplementary Note A1: Seventh Embodiment, FIG. 16 to FIG. 18)

Provided is an autonomous moving apparatus 100 including: a receiving unit 110 that receives signals output from a target object 200a and a target object 200b; a signal identifying unit 137 that identifies an attraction signal from the received signals; and an operation control unit 135 that causes the autonomous moving apparatus 100 to move, based on an incoming direction of the identified attraction signal. The signal identifying unit 137 identifies a first attraction signal output from a first target object 200a that is moving. The operation control unit 135 causes the autonomous moving apparatus 100 to move, based on an incoming direction of the first attraction signal. The signal identifying unit 137 switches an attraction signal to be identified from the first attraction signal to a second attraction signal output from a second target object 200b that is stationary and identifies the second attraction signal. The operation control unit 135 causes the autonomous moving apparatus 100 to move, based on an incoming direction of the second attraction signal.

By setting a moving target to an object moving to a destination, the autonomous moving apparatus 100 is caused to follow the moving object. Then, by changing the moving target to a stationary object, it is possible to cause the autonomous moving apparatus 100 to autonomously move to a place where of the stationary object is located. By switching a target object, a following movement and an autonomous movement can be switched. Therefore, it is not necessary to switch between a following mobile mode (robot), and an autonomous mobile mode (robot), which have different movement control algorithms.

### (Supplementary Note A2: Seventh Embodiment, FIG. 16 to FIG. 18)

Provided is the autonomous moving apparatus 100 according to Supplementary note A1, in which the signal identifying unit 137 switches an attraction signal between the first attraction signal and the second attraction signal, depending on whether the autonomous moving apparatus 100 and the first target object 200a are electrically connected. This enables switching between the following movement and the autonomous movement, depending on whether there is an electrical connection.

### (Supplementary Note A3: Seventh Embodiment, FIG. 16)

Provided is the autonomous moving apparatus 100 according to Supplementary note A2 further including: a first storage case 191 that can store the first target object 200a. Due to the first target object 200a being stored in the first storage case 191, the first target object 200a is electrically connected to the autonomous moving apparatus 100. Due to the first target object 200a being taken out of the first storage case 191, the electrical connection between the first target object 200a and the first storage case 191 is released. Due to the first target object 200a being stored in the first storage case 191, or due to the first target object 200a being taken out of the first storage case 191, it is possible to switch between the following movement and the autonomous movement.

### (Supplementary Note A4: Seventh Embodiment, FIG. 16 to FIG. 18)

Provided is the autonomous moving apparatus 100 according to Supplementary note A1, in which when the signal identifying unit 137 receives a switching operation for switching an attraction signal from the first attraction signal to the second attraction signal from a user of the autonomous moving apparatus 100, the signal identifying unit 137 switches an attraction signal from the first attraction signal to the second attraction signal.

### (Supplementary Note A5: Seventh Embodiment, FIG. 17)

Provided is the autonomous moving apparatus 100 according to any one of Supplementary notes A1 to A4, in which the operation control unit 135 causes the autonomous moving apparatus 100 to move, while keeping a distance between a person holding the first target object 200a, and the autonomous moving apparatus 100 constant. The autonomous moving apparatus 100 can follow the person, while keeping the distance between the person holding the first target object 200a and the autonomous moving apparatus 100 constant.

### (Supplementary Note A6: Seventh Embodiment, FIG. 17)

Provided is the autonomous moving apparatus 100 according to Supplementary note A5, in which the operation control unit 135 measures the distance using a reflected wave of a laser, an acoustic wave, or a radio wave from an object. The autonomous moving apparatus 100 can follow the person, while keeping the distance between the person holding the first target object 200a, and the autonomous moving apparatus 100 constant.

### (Supplementary Note A7: Seventh Embodiment, FIG. 17)

Provided is the autonomous moving apparatus 100 according to Supplementary note A1 including: a second storage case 192 that can store articles 13a to 13d. The signal identifying unit 137 switches an attraction signal from the first attraction signal to the second attraction signal, when all the predetermined articles 13a to 13d are stored in the second storage case 192. This eliminates the necessity of a switching operation performed by a user, and the user's convenience is enhanced.

### (Supplementary Note A8: Seventh Embodiment, FIG. 17)

Provided is the autonomous moving apparatus according to Supplementary note A7, in which the signal identifying unit 137 determines that all the predetermined articles 13a to 13d are stored in the second storage case 192 using RFIDs 14a to 14d attached to the articles 13a to 13d, respectively. The signal identifying unit 137 can determine that all the predetermined articles 13a to 13d are stored in the second storage case 192.

### (Supplementary Note A9: Seventh Embodiment, FIG. 17)

Provided is the autonomous moving apparatus 100 according to any one of Supplementary notes A1 to A3 including: a second storage case 192 that stores articles 13a to 13d. The signal identifying unit 137 switches an attraction signal from the first attraction signal to the second attraction signal, when all the articles 13a to 13d are removed from the second storage case 192, after the end of a purchase procedure of the articles 13a to 13d stored in the second storage case 192. This eliminates the necessity of a switching operation performed by a user, and the user's convenience is enhanced.

### (Supplementary Note A10: Seventh Embodiment, FIG. 17)

Provided is the autonomous moving apparatus 100 according to Supplementary note A9, in which the signal identifying unit 137 determines that all the articles 13a to 13d for which the purchase procedure has been completed, are removed from the second storage case 192, using RFIDs 14a to 14d attached to the articles 13a to 13d, respectively. The signal identifying unit 137 can determine that all the articles 13a to 13d for which the purchase procedure has been completed are removed from the second storage case 192.

### (Supplementary Note A11: Seventh Embodiment, FIGS. 16 to 18)

Provided is an autonomous movement system 1000 including: an autonomous moving apparatus 100 that autonomously moves based on an incoming direction of an attraction signal; a first target object 200a that emits a first attraction signal; and a second target object 200b that emits a second attraction signal. The autonomous moving apparatus 100 includes: a receiving unit 110 that receives signals output from the target object 200a and the target object 200b; a signal identifying unit 137 that identifies an attraction signal from the received signals; and an operation control unit 135 that causes the autonomous moving apparatus 100 to move, based on an incoming direction of the identified attraction signal. The signal identifying unit 137 identifies the first attraction signal output from the moving first target object 200a. The operation control unit 135 causes the autonomous moving apparatus to move, based on an incoming direction of the first attraction signal. The signal identifying unit 137 switches an attraction signal to be identified, from the first attraction signal to the second attraction signal output from the stationary second target object 200b and identifies the second attraction signal. The operation control unit 135 causes the autonomous moving apparatus 100 to move, based on an incoming direction of the second attraction signal.

### REFERENCE SIGNS LIST

13a to 13d Articles, 14a to 14d RFIDs, 100 Autonomous moving apparatus, 110 Receiving unit, 115 Transmitting unit, 135 Operation control unit, 137 Signal identifying unit, 138 Operation control unit, 140 Storage unit, 190 Vehicle body, 191 First storage case, 192 Second storage case, 200 Target object, 200a First target object, 200b Second target object, 220 Receiving unit, 231 Condition determination unit, 300 Target switching device, 400 Integrated control device, 1000 Autonomous movement system, ID1 First target identification information, ID2 Second target identification information, AS Avoiding signal, BC Target switching signal, FD, DD Apparatus, dentification information, PS Attraction signal, PSa First attraction signal, PSb Second attraction signal

1. An autonomous moving apparatus comprising:
a receiving unit that is attached to a moving object and receives signals output from a target object;
a signal identifying unit that identifies an attraction signal from the received signals; and
an operation control unit that causes the moving object to move, based on an incoming direction of the identified attraction signal, wherein
the signal identifying unit identifies a first attraction signal that is output from a first target object as the attraction signal,
the operation control unit causes the moving object to move, based on an incoming direction of the first attraction signal,
when a position of the moving object relative to the first target object satisfies a predetermined condition, the signal identifying unit switches the attraction signal from the first attraction signal to a second attraction signal that is output from a second target object, and identifies the second attraction signal as the attraction signal, and
the operation control unit causes the moving object to move, based on an incoming direction of the second attraction signal.

2. The autonomous moving apparatus according to claim 1 further comprising:
a storage unit that stores data in which the order of the first attraction signal and the second attraction signal identified by the signal identifying unit is determined, wherein
the signal identifying unit switches the attraction signal according to the order stored in the storage unit.

3. The autonomous moving apparatus according to claim 1, wherein
the first attraction signal includes first target identification information used by the signal identifying unit to identify the first attraction signal, and second target identification information used by the signal identifying unit to identify the second attraction signal, and
the signal identifying unit switches the attraction signal from the first attraction signal to the second attraction signal based on the second target identification information included in the first attraction signal.

4. The autonomous moving apparatus according to claim 1, wherein
the first attraction signal includes travel switching information for switching at least one element of a movement and a temporary stop, a movement speed, and a travel algorithm of the autonomous moving apparatus, and
the operation control unit switches the at least one element of a movement and a temporary stop, a movement speed, and a travel algorithm of the autonomous moving apparatus based on the travel switching information.

5. The autonomous moving apparatus according to claim 1 further comprising:
a condition determination unit that determines whether the position of the moving object relative to the first target object satisfies the predetermined condition, based on at least one of signal strength of the first attraction signal received by the receiving unit, and a time change rate of the signal strength.

6. The autonomous moving apparatus according to claim 1, wherein
the signal identifying unit identifies an avoiding signal from the received signals, and
the operation control unit causes the moving object to move in a direction where strength of the avoiding signal decreases, based on the incoming direction of the identified attraction signal.

7. The autonomous moving apparatus according to claim 1 further comprising:
a transmitting unit that transmits an identification signal including information for identifying the autonomous moving apparatus in question from another autonomous moving apparatus, and information indicating priority of the autonomous moving apparatus in question with the other autonomous moving apparatus, wherein
the signal identifying unit identifies the identification signal output from the other autonomous moving apparatus, from the received signals, and
the operation control unit controls an operation of the autonomous moving apparatus in question relative to the other autonomous moving apparatus based on the priority, when a position of the moving object relative to the other autonomous moving apparatus satisfies the predetermined condition.

8. A control system for controlling an autonomous moving apparatus that includes a receiving unit which receives signals, that identifies an attraction signal from the received signals, and that moves based on an incoming direction of the identified attraction signal, the control system comprising:
a plurality of target objects that output mutually different attraction signals, wherein
the plurality of target objects output a target switching signal for causing the autonomous moving apparatus to switch an attraction signal to be identified, when a relative position of the autonomous moving apparatus satisfies the predetermined condition.

9. The control system according to claim 8 further comprising:
a plurality of target switching devices that output the target switching signal, when the relative position of the autonomous moving apparatus satisfies the predetermined condition.

10. The control system according to claim 8, wherein
the target switching signal includes travel switching information for switching at least one element of a movement and a temporary stop, a movement speed, and a travel algorithm of the autonomous moving apparatus.

11. The control system according to claim 8, wherein
the target objects are moving objects.

12. The control system according to claim 8, wherein
each of the plurality of target objects includes:
a receiving unit that receives an identification signal output from the autonomous moving apparatus; and
a condition determination unit that determines whether the relative position of the autonomous moving apparatus satisfies the predetermined condition, based on at least one of signal strength of the identification signal received by the receiving unit, and a time change of the signal strength.

13. The control system according to claim 8 further comprising:
an integrated control device that is communicably connected to each of the plurality of target objects, wherein
the integrated control device determines whether a position of the autonomous moving apparatus relative to each of the plurality of target objects satisfies the predetermined condition, and
the integrated control device instructs, a target object in which the relative position of the autonomous moving apparatus is determined to satisfy the predetermined condition, to output the target switching signal according to the autonomous moving apparatus.

14. The control system according to claim 8, wherein
the plurality of target objects output the target switching signal including identification information of the autonomous moving apparatus, and target identification information for identifying an attraction signal after switching.

15. The control system according to claim 8, wherein
the plurality of target objects output a target switching signal including a plurality of combinations of identification information of the autonomous moving apparatus, and target identification information for identifying an attraction signal after switching that is different according to the autonomous moving apparatus.
